(19) United States
(12) Patent Application Publication
(10) Pub. No.: US 2025/0130409 A1
(43) Pub. Date: Apr. 24, 2025

(54) OPTICAL SYSTEM AND OPTICAL CAMERA WORKING AT FAR-INFRARED WAVEBAND

(71) Applicant: SHENZHEN METALENX TECHNOLOGY CO.,LTD, Shenzhen (CN)

(72) Inventors: Xiaobo ZHAO, Shenzhen (CN); Chenglong HAO, Shenzhen (CN); Fengze TAN, Shenzhen (CN); Jian ZHU, Shenzhen (CN)

(73) Assignee: SHENZHEN METALENX TECHNOLOGY CO.,LTD, Shenzhen (CN)

(21) Appl. No.: 18/915,356

(22) Filed: Oct. 15, 2024

(30) Foreign Application Priority Data
Oct. 18, 2023 (CN) 202311351665.2
Oct. 18, 2023 (CN) 202322798507.3

(51) Int. Cl. G02B 13/00; G02B 7/02; G03B 17/12

(52) U.S. Cl. CPC G02B 13/008; G02B 7/026; G02B 13/0015; G02B 13/0085; G03B 17/12; G02B 2207/101

(57) ABSTRACT

An optical system and an optical camera working at a far-infrared waveband are provided. The optical system includes two optical elements, the two optical elements being, along the optical axis in order from an object side to an image side: a metalens and a refractive lens; each of two optical elements including an object-side surface facing towards the object side and an image-side surface facing towards the image side; the metalens including a substrate and a plurality of nanostructures, and the plurality of nanostructures are set on the image-side surface of the metalens; when a light passes through the image-side surface of the metalens, the incident angle of the light is less than or equal to 45°; the object-side surface of the refractive lens is a concave surface, and the image-side surface of the refractive lens is a convex surface; and the refractive lens has positive refractive power.

### CROSS-REFERENCE TO RELATED APPLICATION

This application claims the benefit of priority from Chinese Patent Application No. 202311351665.2 and No. 202322798507.3, filed on Oct. 18, 2023. The content of the aforementioned application, including any intervening amendments thereto, is incorporated herein by reference in its entirety.

### TECHNICAL FIELD

The present disclosure relates to a field of an optical lens, in particular to an optical system and an optical camera working at a far-infrared waveband.

### BACKGROUND

For the optical system working at the far-infrared waveband, in order to decrease the volume of the optical system, the prior art has provided an optical system composed of the metalens and the refractive lens. However, the optical system in prior art cannot satisfy larger FOV (field of view) and high transmittance at the same time.

### SUMMARY

In order to solve the above technical problem, an optical system and an optical camera are provided according to the present application. The optical system provided by the present application is capable of satisfying the requirements of the optical system for larger FOV and high transmittance at the same time.

In the first aspect, an optical system working at a far-infrared waveband is provided, an optical system working at a far-infrared waveband, including two optical elements, the two optical elements being, along the optical axis in order from an object side to an image side: a metalens and a refractive lens;
each of two optical elements including an object-side surface facing towards the object side and an image-side surface facing towards the image side;
where the metalens includes a substrate and a plurality of nanostructures, and the plurality of nanostructures are set on the image-side surface of the metalens; when a light passes through the image-side surface of the metalens, the incident angle of the light is less than or equal to 45°;
the object-side surface of the refractive lens is a concave surface, and the image-side surface of the refractive lens is a convex surface; and the refractive lens has positive refractive power.

Optionally, the optical system satisfies the following condition:

$$2 * arcsin ( \frac{\sqrt{2}}{2} {n}_{1} ) > Fov$$

where Fov is a field of view of the optical system, and the unit of the Fov is expressed in degree; nᵢ is the refractive index.

Optionally, the optical system satisfies the following condition:

$$15.25 \leq \frac{k * σ + TTL}{{f}_{2}} \leq 20.$$

where k is a correction coefficient, and the unit of k is expressed in mm*° C.; σ is a refraction temperature coefficient, and the unit of σ is expressed in 1/° C.; TTL is a total track length of the optical system, and the unit of TTL is expressed in mm; f₂ is a focal length of the refractive lens, and the unit of f₂ is expressed in mm.

Optionally, the optical system satisfies the following condition:

$$0.25 \leq \frac{( {c}_{1} - {c}_{2} ) * H}{{ϕ}_{m}} \leq 1.20$$

where c₁ is a curvature radius of the object-side surface of the refractive lens and the unit of the curvature radius is expressed of 1/mm; c₂ is a curvature radius of the image-side surface of the refractive lens and the unit of the curvature radius is expressed of 1/mm; H is a thickness of the refractive lens and the unit of the thickness of the refractive lens is expressed in mm; ϕₘ is a focal power of the metalens and the unit of the focal power is expressed in 1/mm.

Optionally, the optical system satisfies the following condition:

$$0.90 \leq \frac{L}{BFL} \leq 2.00$$

where Lis a paraxial distance between the object-side surface of the metalens and the image-side surface of the refractive lens, BFL is a distance between the image-side surface of the refractive lens and image plane; and the unit of L and BFL are the same.

Optionally, the plurality nanostructures are positive nanostructures.

Optionally, the plurality nanostructures are negative nanostructures.

Optionally, the optical system also includes an aperture slot; the aperture slot is next to the metalens and is set on the surface of the metalens.

Optionally, the optical system also includes an aperture slot, and an air gap is set between the aperture slot and the metalens.

Optionally, the optical system includes an optical window; the optical window is set between the refractive lens and the image plane.

Optionally, the field of view of the optical system satisfies:

$$117 ° \leq Fov \leq 123 °$$

where, Fov is a field of view of the optical system.

Optionally, the total track length of the optical system is less than or equal to 3.8 mm.

Optionally, the F number of the optical system is less than or equal to 1.1.

An optical camera working at a far-infrared waveband is provided, where the optical camera includes a lens barrel and the optical system;
an inner wall of the lens barrel is set with a staircase structure;
the metalens and refractive lens are set on the staircase structure;
the optical camera further includes a connection structure, and the connection structure is used to fix the metalens and refractive lens on the staircase structure.

Optionally, the connection structure is a pressure ring.

Optionally, the connection structure is dispensing.

In the present application, the optical system including two optical elements, the two optical elements being, along the optical axis in order from an object side to an image side: a metalens and a refractive lens; each of two optical elements including an object-side surface facing towards the object side and an image-side surface facing towards the image side; where the metalens includes a substrate and a plurality of nanostructures, and the plurality of nanostructures are set on the image-side surface of the metalens; when a light passes through the image-side surface of the metalens, the incident angle of the light is less than or equal to 45°; the object-side surface of the refractive lens is a concave surface, and the image-side surface of the refractive lens is a convex surface; and the refractive lens has positive refractive power. Thus, incident light can be incident to the optical system with a larger incident angle while doesn't produce significant resonance, so that the optical system is capable of satisfying the requirements of larger FOV and high transmittance at the same time.

Other features and advantages of the present application will become apparent by the detailed description below, or will be acquired in part by the practice of the present application. It should be understood that the above description is general, and the detailed description described below are exemplary only, and will not limit this application.

### BRIEF DESCRIPTION OF THE DRAWINGS

The above and other targets, features and advantages of the example embodiment thereof by reference to the accompanying drawings.

FIG. 1 shows a schematic diagram of the architectural layout of the optical system working at the far-infrared waveband in one embodiment provided by the present application.

FIG. 2 shows a schematic diagram of the architectural layout of the optical system working at the far-infrared waveband in one embodiment provided by the present application.

FIG. 3 shows a schematic diagram of the architectural layout of the optical system working at the far-infrared waveband in one embodiment provided by the present application.

FIG. 4 shows a curve diagram at room temperature between the MTF (modulation transfer function) and field of view of the optical system working at the far-infrared waveband in one embodiment provided by the present application.

FIG. 5 shows a spot diagram at room temperature of the optical system working at the far-infrared waveband in one embodiment provided by the present application.

FIG. 6 shows a curve diagram at the temperature of −40° C. between the MTF and field of view of the optical system working at the far-infrared waveband in one embodiment provided by the present application.

FIG. 7 shows a spot diagram at the temperature of −40° C. of the optical system working at the far-infrared waveband in one embodiment provided by the present application.

FIG. 8 shows a curve diagram at the temperature of 80° C. between the MTF and field of view of the optical system working at the far-infrared waveband in one embodiment provided by the present application.

FIG. 9 shows a curve diagram at the temperature of 80° C. of the optical system working at the far-infrared waveband in one embodiment provided by the present application.

FIG. 10 shows a field curvature diagram of the optical system working at the far-infrared waveband in one embodiment provided by the present application.

FIG. 11 shows a distortion diagram of the optical system working at the far-infrared waveband in one embodiment provided by the present application.

FIG. 12 shows a wavefront aberration diagram in the axial direction of the optical system working at the far-infrared waveband in one embodiment provided by the present application.

FIG. 13 shows a chromatic aberration diagram in the vertical axis direction of the optical system working at the far-infrared waveband in one embodiment provided by the present application.

FIG. 14 shows a schematic diagram of the architectural layout of the optical system working at the far-infrared waveband in one embodiment provided by the present application.

FIG. 15 shows a curve diagram at room temperature between the MTF and field of view of the optical system working at the far-infrared waveband in one embodiment provided by the present application.

FIG. 16 shows a spot diagram at room temperature of the optical system working at the far-infrared waveband in one embodiment provided by the present application.

FIG. 17 shows a curve diagram at the temperature of −40° C. between the MTF and field of view of the optical system working at the far-infrared waveband in one embodiment provided by the present application.

FIG. 18 shows a spot diagram at the temperature of −40° C. of the optical system working at the far-infrared waveband in one embodiment provided by the present application.

FIG. 19 shows a curve diagram at the temperature of 80° C. between the MTF and field of view of the optical system working at the far-infrared waveband in one embodiment provided by the present application.

FIG. 20 shows a curve diagram at the temperature of 80° C. of the optical system working at the far-infrared waveband in one embodiment provided by the present application.

FIG. 21 shows a field curvature diagram of the optical system working at the far-infrared waveband in one embodiment provided by the present application.

FIG. 22 shows a distortion diagram of the optical system working at the far-infrared waveband in one embodiment provided by the present application.

FIG. 23 shows a wavefront aberration diagram in the axial direction of the optical system working at the far-infrared waveband in one embodiment provided by the present application.

FIG. 24 shows a chromatic aberration diagram in the vertical axis direction of the optical system working at the far-infrared waveband in one embodiment provided by the present application.

FIG. 25 shows a schematic diagram of the architectural layout of the optical system working at the far-infrared waveband in one embodiment provided by the present application.

FIG. 26 shows a curve diagram at room temperature between the MTF and field of view of the optical system working at the far-infrared waveband in one embodiment provided by the present application.

FIG. 27 shows a spot diagram at room temperature of the optical system working at the far-infrared waveband in one embodiment provided by the present application.

FIG. 28 shows a curve diagram at the temperature of −40° C. between the MTF and field of view of the optical system working at the far-infrared waveband in one embodiment provided by the present application.

FIG. 29 shows a spot diagram at the temperature of −40° C. of the optical system working at the far-infrared waveband in one embodiment provided by the present application.

FIG. 30 shows a curve diagram at the temperature of 80° C. between the MTF and field of view of the optical system working at the far-infrared waveband in one embodiment provided by the present application.

FIG. 31 shows a curve diagram at the temperature of 80° C. of the optical system working at the far-infrared waveband in one embodiment provided by the present application.

FIG. 32 shows a field curvature diagram of the optical system working at the far-infrared waveband in one embodiment provided by the present application.

FIG. 33 shows a distortion diagram of the optical system working at the far-infrared waveband in one embodiment provided by the present application.

FIG. 34 shows a wavefront aberration diagram in the axial direction of the optical system working at the far-infrared waveband in one embodiment provided by the present application.

FIG. 35 shows a chromatic aberration diagram in the vertical axis direction of the optical system working at the far-infrared waveband in one embodiment provided by the present application.

FIG. 36 shows a schematic diagram of the architectural layout of the optical system working at the far-infrared waveband in one embodiment provided by the present application.

FIG. 37 shows a curve diagram at room temperature between the MTF and field of view of the optical system working at the far-infrared waveband in one embodiment provided by the present application.

FIG. 38 shows a spot diagram at room temperature of the optical system working at the far-infrared waveband in one embodiment provided by the present application.

FIG. 39 shows a curve diagram at the temperature of −40° C. between the MTF and field of view of the optical system working at the far-infrared waveband in one embodiment provided by the present application.

FIG. 40 shows a spot diagram at the temperature of −40° C. of the optical system working at the far-infrared waveband in one embodiment provided by the present application.

FIG. 41 shows a curve diagram at the temperature of 80° C. between the MTF and field of view of the optical system working at the far-infrared waveband in one embodiment provided by the present application.

FIG. 42 shows a curve diagram at the temperature of 80° C. of the optical system working at the far-infrared waveband in one embodiment provided by the present application.

FIG. 43 shows a field curvature diagram of the optical system working at the far-infrared waveband in one embodiment provided by the present application.

FIG. 44 shows a distortion diagram of the optical system working at the far-infrared waveband in one embodiment provided by the present application.

FIG. 45 shows a wavefront aberration diagram in the axial direction of the optical system working at the far-infrared waveband in one embodiment provided by the present application.

FIG. 46 shows a chromatic aberration diagram in the vertical axis direction of the optical system working at the far-infrared waveband in one embodiment provided by the present application.

FIG. 47 shows a schematic diagram of the architectural layout of the optical system working at the far-infrared waveband in one embodiment provided by the present application.

FIG. 48 shows a curve diagram at room temperature between the MTF and field of view of the optical system working at the far-infrared waveband in one embodiment provided by the present application.

FIG. 49 shows a spot diagram at room temperature of the optical system working at the far-infrared waveband in one embodiment provided by the present application.

FIG. 50 shows a curve diagram at the temperature of −40° C. between the MTF and field of view of the optical system working at the far-infrared waveband in one embodiment provided by the present application.

FIG. 51 shows a spot diagram at the temperature of −40° C. of the optical system working at the far-infrared waveband in one embodiment provided by the present application.

FIG. 52 shows a curve diagram at the temperature of 80° C. between the MTF and field of view of the optical system working at the far-infrared waveband in one embodiment provided by the present application.

FIG. 53 shows a curve diagram at the temperature of 80° C. of the optical system working at the far-infrared waveband in one embodiment provided by the present application.

FIG. 54 shows a field curvature diagram of the optical system working at the far-infrared waveband in one embodiment provided by the present application.

FIG. 55 shows a distortion diagram of the optical system working at the far-infrared waveband in one embodiment provided by the present application.

FIG. 56 shows a wavefront aberration diagram in the axial direction of the optical system working at the far-infrared waveband in one embodiment provided by the present application.

FIG. 57 shows a chromatic aberration diagram in the vertical axis direction of the optical system working at the far-infrared waveband in one embodiment provided by the present application.

### DETAILED DESCRIPTION OF THE EMBODIMENTS

The embodiments will be described more comprehensively with reference to the accompanying drawings. However, the embodiments can be implemented in various forms and should not be understood to be limited to the examples elaborated herein; instead, providing these embodiments makes the description of this application more comprehensive and complete and fully communicates the idea of the embodiment to those skilled in the art. The attached drawings are only schematic illustrations of this application and are not necessarily proportional drawings. The same reference marks in the figure indicate the same or similar parts, and their repeated descriptions will be omitted.

Furthermore, the described features, structures or features may be combined in one or more embodiments in any suitable manner. In the following description, many specific details are provided to give a full understanding of the exemplary embodiments of this application. However, those skilled in the art will be aware that one or more of the specific details may be omitted from the present technical solution, or other modules, components, etc. may be adopted. In other cases, aspects of the present application are blurred without detailed showing or describing the public structure, method, implementation or operation to avoid over dominance.

For the optical system working at far-infrared waveband, the optical system composed of metalens and refractive lens has been provided by the prior art. Compared with the volume of the refractive lens, the volume of the metalens is smaller, thus the optical system in the prior art obtains a decreased volume of the optical system. However, in the prior art, if the optical system has a larger FOV, when light passes through the metalens with a larger incident angle, the light will produce a significant resonance and will reduce the transmittance of the optical system. Thus, in the method provided by the prior art, the optical system cannot satisfy the requirements of larger FOV and high transmittance at the same time.

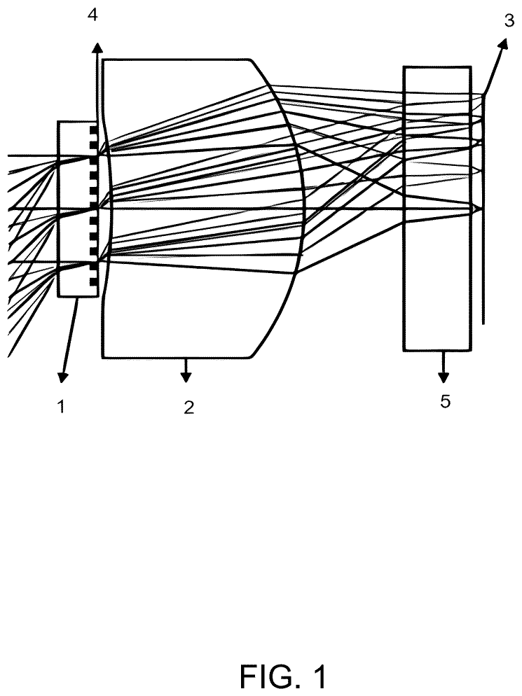

In order to overcome the above disadvantages, an optical system and an optical camera working at a far-infrared waveband are provided by the present application. FIG. 1 shows a schematic diagram of the architectural layout of the optical system working at the far-infrared waveband in one embodiment provided by the present application. In FIG. 1, the object plane of optical system is on the left of FIG. 1, and the image plane of optical system is on the right of FIG. 1. Because the position of object plane is uncertain, the position of object plane hasn't been shown.

As shown in FIG. 1, the optical system working at a far-infrared waveband, including two optical elements, the two optical elements being, along the optical axis in order from an object side to an image side: a metalens 1 and a refractive lens 2.

The metalens includes a substrate and a plurality of unit cells, and a plurality of nanostructures are set in the unit cells. The vertex and/or the center of the unit cell is set with nanostructures. The filler material filled between the nanostructures may be air or other transparent materials at the working waveband. By the modulation of the unit cells, the metalens provides the phase needed by the optical system. After passing through the metalens, the lights are incident to the refractive lens 2.

In the present embodiment, the object-side surface of the refractive lens is a concave surface, and the image-side surface of the refractive lens is a convex surface; and the refractive lens has positive refractive power. It can be seen that the shape of whole refractive lens 2 is a crescent towards the image plane 3. Moreover, because the refractive lens 2 has a negative focal power, the refractive lens 2 is capable of collimating the lights, thus the lights will be collimated from the object plane to image plane 3.

It should be noted, the applicants found the main reason why the resonance will be produced when light passes through the metalens is that the incident angle of the incident light is greater than 45° when the light passes through the surface of the nanostructures on the metalens. To avoid producing the resonance when the light passes through the metalens, the incident angle of light should be controlled to be less or equal to 45° when the light passes through the nanostructures of metalens.

At the same time, for the optical system provided in the present application, the target requirement is to have the ability to allow incident light with a larger angle to be incident, that is, when the light passes through the nanostructures on the object-side surface of the metalens 1, the incident angle is greater than or equal to 45°, so that the optical system to be provided in the present application can have a larger FOV.

It can be seen that if the optical system can satisfy larger FOV and high transmittance at the same time, two conditions of “the incident angle is less than or equal to 45° when the incident light passes through the nanostructures of the metalens” and “the incident angle is less than or equal to 45° when the incident light is incident to the object-side surface of the metalens” need to be satisfied. And if the nanostructures are set on the object-side surface of the metalens, the two conditions can't be satisfied at the same time. That is, satisfying the first condition to have high transmittance of the metalens leads to the second condition can't be satisfied; and satisfying the second condition to have larger FOV leads to the first condition can't be satisfied and the optical system can't have high transmittance.

Therefore, in the present application, the nanostructures are set on the image-side surface 4 of the metalens. At the same time, the incident angle is controlled to be less than or equal to 45° when the incident light passes through the image-side surface 4 of the metalens. Satisfying the two conditions makes the lights incident to the optical system with a larger angle, while will not produce significant resonance, thus the optical system has the larger FOV and high transmittance at the same time.

In one embodiment, the optical system provided by the present application satisfies the condition:

$$2 * arcsin ( \frac{\sqrt{2}}{2} {n}_{1} ) > Fov$$

Fov is the field of view of the optical system, and the unit of the Fov is expressed in degree; n; is the refractive index.

Specifically, in the present application, the incident light to the optical system will be incident to the object-side surface of the metalens firstly, after the refraction, the incident light will be outgoing from the object-side surface 4 of the metalens. It should be understood that the incident angle on the object-side surface is equal to the outgoing angle on the image-side surface of the metalens. Therefore, the incident angle of the object-side surface of the metalens is controlled to be less than or equal to 45°, that is, the outgoing angle of the image-side surface of the metalens is controlled to be less than or equal to 45°. The outgoing angle of the object-side surface of the metalens is recorded to be θ₁, and the condition to be satisfied is θ₁≤45°.

According to the refraction law,

$$1 * sin \frac{Fov}{2} = {n}_{1} * sin {θ}_{1}$$

is obtained; where 1 represents the refractive index of air. And

$${θ}_{1} = arc sin ( \frac{sin \frac{Fov}{2}}{{n}_{1}} )$$

is obtained.

Thus, θ₁≤45° is converted into

$$2 * arcsin ( \frac{\sqrt{2}}{2} {n}_{1} ) \geq Fov .$$

It should be noted that in the optical system the surface receiving the light is the object-side surface of the metalens, and the object-side surface of the metalens 1 is usually a plane, thus the incident angle of the object-side surface should be less than 90°. From that can be seen, the FOV of the optical system needs to be less than 180°. Because the maximum value of

$$2 * arcsin ( \frac{\sqrt{2}}{2} {n}_{1} )$$

is 180°, in order to make sure that the FOV of the optical system is less than 180°,

$$2 * arc sin ( \frac{\sqrt{2}}{2} {n}_{1} ) \geq Fov$$

is converted into

$$2 * arcsin ( \frac{\sqrt{2}}{2} {n}_{1} ) > Fov .$$

It can be seen that when the FOV is determined, by adjusting the refractive index nᵢ of the metalens, the optical system satisfies condition (1):

$$2 * arc sin ( \frac{\sqrt{2}}{2} {n}_{1} ) > Fov \qquad ( 1 )$$

Thus the incident angle is less than or equal to 45°, when the light is incident to the object-side surface of the metalens, and the FOV of the optical system is less than 180°.

Further, it should be noted that when n₁ is equal to

$$\sqrt{2} , 2 * arc sin ( \frac{\sqrt{2}}{2} {n}_{1} )$$

gets the maximum value of 180°, but it doesn't mean the maximum value of n₁ only can be \sqrt{2}. As shown in the following condition, in the present application, when

$${n}_{1} \geq \sqrt{2} , 2 * arc sin ( \frac{\sqrt{2}}{2} {n}_{1} )$$

is equal to 180°, so that the FOV of the optical system is less than 180°, which means the optical system satisfies the following condition (2):

$$\{ \begin{matrix}2 * arc sin ( \frac{\sqrt{2}}{2} {n}_{1} ) > Fov & \\ 2 * arc sin ( \frac{\sqrt{2}}{2} {n}_{1} ) = 180 ° & {n}_{1} \geq \sqrt{2}\end{matrix} \qquad ( 2 )$$

Preferably, in one embodiment, the optical system satisfies the following condition (3):

$$\{ \begin{matrix}2 * arc sin ( \frac{1}{2} {n}_{1} ) > Fov & \\ 2 * arc sin ( \frac{1}{2} {n}_{1} ) = 180 ° & {n}_{1} \geq 2\end{matrix} \qquad ( 3 )$$

In the present application, when the target requirement of FOV is pre-set, the optical system satisfies the condition

$$2 * arcsin ( \frac{1}{2} {n}_{1} ) > Fov$$

by adjusting the refractive index n₁ of the metalens 1. It can be seen that the incident angle of the object-side surface 4 of metalens 1 is less than or equal to 30°, at the same time, FOV of the optical system is equal to 180°. Similarly, the deduction of condition (1) is the same in the previous embodiment, which will not be repeated here.

In one embodiment, the optical system provided by the present application satisfies the following condition:

$$15.25 \leq \frac{k * σ + TTL}{{f}_{2}} \leq 20. \qquad ( 4 )$$

k is a correction coefficient, and the unit of k is expressed in mm*° C.; σ is a refraction temperature coefficient, and the unit of σ is expressed in 1/° C.; TTL is a total track length of the optical system, and the unit of TTL is expressed in mm; f₂ is a focal length of the refractive lens, and the unit of f₂ is expressed in mm.

The refraction temperature coefficient σ is used to describe the velocity changes of refractive index of the refractive lens 2 changing with the temperature. The larger the σ is, the changes of refractive index will be greater at the same temperature environment. Conversely, with the smaller σ is, the changes of the refractive index of the refractive lens 2 at the same temperature environment are less.

It should be noted that due to the metalens is not sensitive to the temperature, and there is almost no thermal effect, so that the thermal effect of the optical system provided in this application is mainly caused by the refractive lens 2. Therefore, to realize the athermalization for the optical system, the refraction temperature coefficient of the refractive lens 2, the total track length of the optical system, and the effective focal length of the refractive lens 2 need to be controlled in this embodiment.

Specifically, the larger the σ is, the larger the optical system influenced by the thermal difference will be; the larger the TTL is, the larger the optical system influenced by the thermal difference will be; the smaller the f₂ is, the larger the optical system influenced by the thermal difference will be. Moreover, the influence of σ caused by the optical system is greater than the influence of TTL caused by the optical system, thus in the present application, the correction coefficient σ used to correct is 1*105.

Furthermore, the highest value of the condition is configured to be 20.00, thus the influence caused by the thermal effect for σ, TTL and f₂ is limited, so that the optical system is capable of realizing athermalization. Moreover, the lowest value is configured to be 15.25, thus the optical system has the basic design conditions, and the refractive lens 2 has a reasonable focal length.

Preferably, in one embodiment, the optical system satisfies the following condition:

$$16.14 \leq \frac{k * σ + TTL}{{f}_{2}} \leq 18.35 \qquad ( 5 )$$

In one embodiment, the optical system satisfies the following condition:

$$0.25 \leq \frac{( {c}_{1} - {c}_{2} ) * H}{{ϕ}_{m}} \leq 1.2 \qquad ( 6 )$$

c₁ is the curvature radius of the object-side surface of the refractive lens and the unit of the curvature radius is expressed of 1/mm; c₂ is the curvature radius of the image-side surface of the refractive lens and the unit of the curvature radius is expressed of 1/mm; H is the thickness of the refractive lens and the unit of the thickness of the refractive lens is expressed in mm; ϕₘ is the focal power of the metalens and the unit of the focal power is expressed in 1/mm.

c₁, c₂ and H all are parameters related to the focal power. Therefore, in the present application, the condition is capable of limiting the focal power of the metalens 1 and the refractive lens 2, at the same time, the condition is capable of limiting the shape and the size of the refractive lens 2.

Specifically, the highest value of the condition is configured to be 1.20 to make sure the metalens 1 may provide enough focal power, thus the metalens 1 is capable of correcting the aberrations, especially for the distortion and coma; at the same time, the highest value of the condition also can avoid the thickness of the refractive lens 2 being too large, thus avoids adverse effect on the transmittance and the weight of the optical system.

And the lowest value of the condition is configured to be 0.25 to avoid the metalens providing too large focal power, thus avoid the metalens 1 producing too much negative dispersion; at the same time, making sure the refractive lens 2 providing enough focal power, thus the refractive lens 2 can provide positive dispersion to make up the negative dispersion of the metalens 1, so that can correct the chromatic aberrations of the optical system.

Preferably, in one embodiment, the optical system satisfies the following condition:

$$0.33 \leq \frac{( {c}_{1} - {c}_{2} ) * H}{{ϕ}_{m}} \leq 0.97 \qquad ( 7 )$$

In one embodiment, the optical system satisfies the following condition:

$$0.9 \leq \frac{L}{BFL} \leq 2. \qquad ( 8 )$$

L is a paraxial distance between the object-side surface of the metalens and the image-side surface of the refractive lens, BFL is a distance between the image-side surface of the refractive lens and image plane; and the unit of L and BFL are the same.

In one embodiment, the condition can limit the TTL (total track length) of the optical system, at the same time, the condition can satisfy the assembly requirements of the optical system.

Specifically, the highest value of the condition is configured to be 2.00 to avoid L (the total track length of the optical system, namely, the distance between the object-side surface and the image-side surface) being too large, thus to avoid the volume of the optical system being too large; at the same time, the highest value of the condition is configured to be 2.00 to avoid the back focal length being too short, thus avoids the metalens being hard to assemble. The lowest value of the condition is configured to be 0.90 to avoid the back focal length being too large, thus avoids the volume of the optical system being too large.

Preferably, in one embodiment, the optical system satisfies the following condition:

$$1.23 \leq \frac{L}{BFL} \leq 1.74 \qquad ( 9 )$$

In one embodiment, the nanostructures of the metalens 1 may be positive nanostructures, or may be negative nanostructures.

Specifically, during the assembly of the optical system, compared with the positive nanostructures, the negative nanostructures are harder to damage, thus can provide the security of the structure of the metalens.

In one embodiment, the optical systems also include the aperture slot, and the aperture slot is next to the metalens and may be set on the surface of the metalens, or an air gap may be set between the aperture slot and the metalens.

In the present embodiment, the aperture slot is used to control the light intake. Specifically, the aperture slot may be set on the object-side surface of the metalens 1; or the aperture slot may be set on the image-side surface of the metalens 1; or an air gap may be set between the aperture slot and the metalens 1, and no other optical elements are set between the aperture slot and the metalens. However, other non-optical elements (e. g. elements used for connecting or strutting) may be provided.

In the present embodiment, the optical system further includes: an optical window glass and the optical window glass 5 is set between the refractive lens 2 and the image plane 3.

In the present application, the optical window glass 5 is used to protect the refractive lens 2, thus the structure security of the refractive lens 2 is improved.

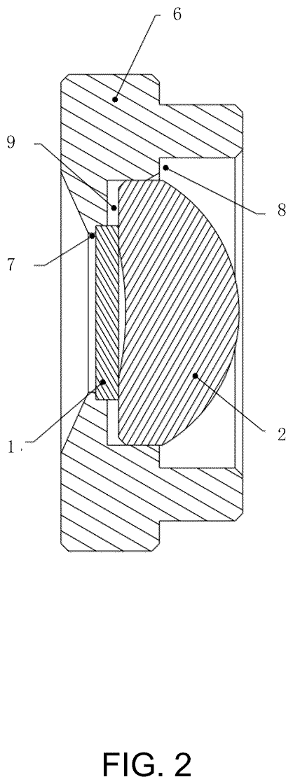

In one embodiment, an optical camera working at a far-infrared waveband. The optical camera includes a lens barrel 6 and an optical system provided by any embodiment above. FIG. 2 shows a schematic diagram of the architectural layout of the optical system working at the far-infrared waveband in one embodiment provided by the present application. Referring to FIG. 2, in the optical camera provided in this application, an inner wall of the lens barrel 6 is set with a staircase structure; and the metalens 1 and refractive lens 2 are set on the staircase structure. Preferably, the staircase structure includes at least two staircases to support the metalens 1 and the refractive lens 2 on the different staircases.

And a connection structure is set between the metalens 1 and a joint 7 of the staircase structure, and the connection structure is used to fix the metalens 1 on the staircase structure. The connection structure is mainly used to improve the structural firmness of the metalens 1. And a connection structure is set between the refractive lens 2 and a joint 8 of the staircase structure, and the connection structure is used to fix the refractive lens 2 on the staircase structure. The connection structure is mainly used to improve the structural firmness of the refractive lens 2. These two parts of the connection structure aren't only used to fix, but also can play the role of waterproof and dustproof.

In one embodiment, the connection structure used to fix the metalens 1 and the refractive lens 2 may be a pressure ring, or dispensing.

It should be noted that the connection structure used to fix the metalens 1, and the connection structure used to fix the refractive lens 2 may be set by different methods, or may be set by the same method. Namely, both the two parts of the connection structure may be pressure ring, or both the two parts of the connection structure may be dispensing. Or, one part of the connection structure may be a pressure ring and another part of the connection structure may be a dispensing.

As shown in FIG. 2 in one embodiment, in the process of assembling an optical camera, there is a void region 9 between the metalens 1 and the staircase structure, and between the refractive lens 2 and the staircase structure. To ensure the seal-ability of the optical camera, the void region 9 may be sealed by dispensing.

TABLE 1
Target requirements for the various system
parameters of the optical system

| System Parameters | Data | |
|---|---|---|
| TTL | ≤3.8 | mm |
| FOV | 120° (3%) | |
| Distortion | <50% | |
| F number | ≤1.1 | |
| MTF | >0.15@1F 42 cyc/mm | |
| Working waveband | 8~12 | μm |

Table 1 shows the target requirements for the various system parameters of the optical system. In detail, the optical system is working at the far-infrared waveband, namely 8-12 μm; The TTL (total track length) of the optical system is less than or equal to 3.8 mm; FOV (field of view) of the optical system is greater than or equal to 117° and is less than or equal to 123°; the distortion of the imaging is less than 50%; F number is less than or equal to 1.1. And the target requirement of MTF (modulation transfer function) at the cut-off frequency of 42 cyc/mm at all FOV is greater than 0.15. And MTF is an important indicator used to describe the image quality of optical system. The closer the value of MTF is to the diffraction limit, the better the image quality.

With the target requirements shown in Table 1, the present application provides five embodiments with five optical systems that meet the target requirements shown in Table 1. Next, the five optical systems provided in this application are described in detail.

### Embodiment 1

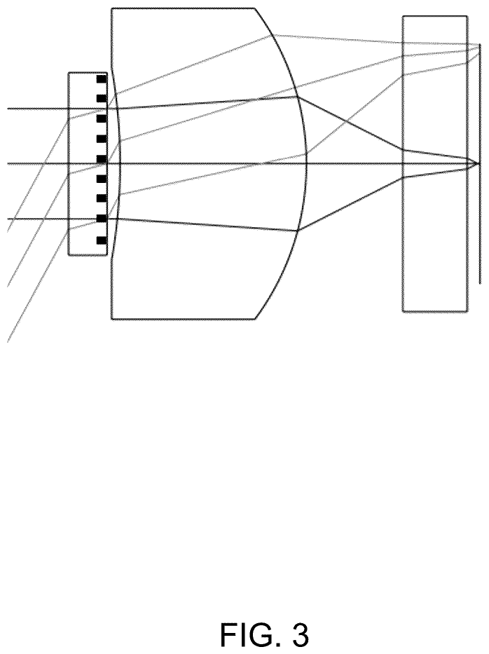

FIG. 3 shows a schematic diagram of the architectural layout of the optical system and the optical camera working at the far-infrared waveband in one embodiment provided by the present application. As shown in FIG. 3, in embodiment 1, the optical system working at a far-infrared waveband, including 4 optical elements, the 4 optical elements being, along the optical axis in order from an object side to an image side: a metalens, an aperture slot, a refractive lens and an optical window glass. And the aperture slot is set on the image-side surface of the metalens.

TABLE 2
The various system parameters
of the optical system

| System Parameters | Data | |
|---|---|---|
| TTL | 3.2 | mm |
| FOV | 122.6° | |
| F number | 1.1 | |
| Effective focal length | 0.92 | mm |
| Working waveband | 8~12 | μm |

As can be seen from Table 2, the optical system provided by the present application works at the waveband from 8 μm to 12 μm; the optical system has a TTL of 3.2 mm, and the TTL is less than that in the target requirement of 3.8 mm, which can fully satisfy the requirement of miniaturization. The F number of the optical system is 1.1 and the F number is equal to the target requirement, which can fully satisfy the requirements of the optical system for light intake.

Along the direction from the object side to the image side, each surface of the optical system is numbered. After summarizing the parameters of each surface, Table 3 is obtained as shown below.

TABLE 3
parameters of each surface of the
optical system in Embodiment 1

| Surface | | Curvature | | |
|---|---|---|---|---|
| number | Type of surfaces | radius | Thickness | Material |
| 1 | Object plane | Infinite | — | — |
| 2 | Spherical plane | Infinite | 0.30 mm | Silicon |
| 3 | Structural | Infinite | 0.10 mm | — |
| | surface | | | |
| | (Aperture slot) | | | |
| 4 | Spherical plane | −4.23 mm | 1.45 mm | Silicon |
| 5 | Spherical plane | −2.00 mm | 0.75 mm | — |
| 6 | Spherical plane | Infinite | 0.50 mm | Silicon |
| 7 | Spherical plane | Infinite | 0.10 mm | — |
| 8 | Image plane | Infinite | — | — |

The surface 1 is an object plane. And surface 2 is an object-side surface of the metalens. The surface 3 is an image-side surface of the metalens 1, because the nanostructures are set on the image-side surface of the metalens, the image-side of the metalens is recorded as a structural surface. And the aperture slot is co-planar with the image-side surface of the metalens. The surface 4 is an object-side surface of refractive lens. The surface 5 is the image-side surface of the refractive lens. The surface 6 is the object-side surface of the optical window glass. The surface 7 is the image-side surface of the optical window glass. The surface 8 is the image plane. It can be seen from Table 3 that the curvature radius of surface 1 is infinite (namely, surface 1 is a plane), and the paraxial distance between the surface 1 and surface 2 is uncertain. And air is filled between the surface 1 and surface 2. The surface 2 is a plane. The paraxial distance between the surface 2 and the surface 3 is 0.30 mm, and the metalens is made of silica. The surface 3 is a plane, and the paraxial distance between the surface 3 and surface 4 is 0.10 mm, and air is filled between the surface 3 and surface 4. The surface 4 is a spherical plane with a curvature radius of −4.23 mm, and the paraxial distance between the surface 4 and surface 5 is 1.45 mm, and the refractive lens is made of silicon. The surface 5 is a spherical plane with a curvature radius of −2.00 mm, and the paraxial distance between the surface 6 and surface 5 is 0.75 mm, and air is filled between the surface 5 and surface 6. The surface 6 is a plane. And the paraxial distance between the surface 6 and surface 7 is 0.50 mm, and the optical window glass is made of silica. The surface 7 is a plane, and the paraxial distance between the surface 7 and surface 8 is 0.10 mm, and air is filled between the surface 7 and surface 8. The surface 8 is a plane.

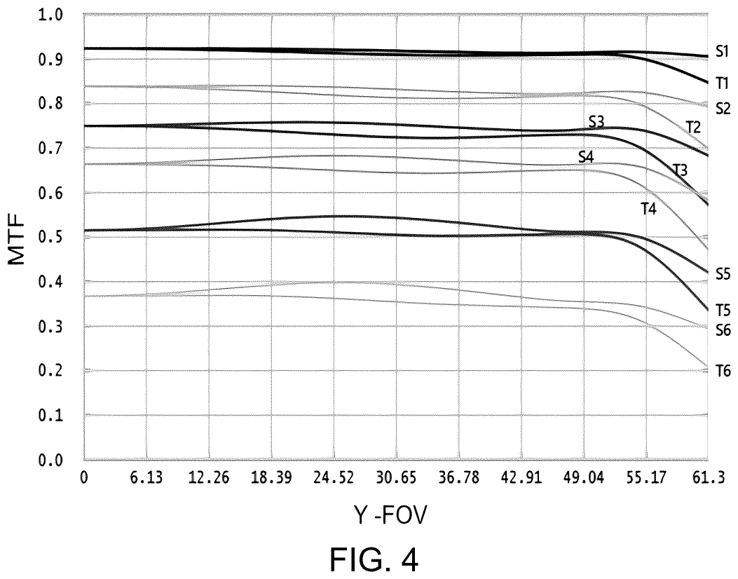

FIG. 4 shows a curve diagram at room temperature between the MTF and field of view of the optical system working at the far-infrared waveband in embodiment 1 provided by the present application. In general, the room temperature refers to the environment of 20° C. or 25° C. In FIG. 4, the horizontal axis represents the field of view on the Y axis with a unit of degree; the vertical axis represents the MTF value. In FIG. 4, T represents the meridional curve and S represents the sagittal curve. The meridional curve T1 and sagittal curve S1 correspond to the cut-off frequency of 5.00 (cyc/mm); the meridional curve T2 and sagittal curve S2 correspond to the cut-off frequency of 10.00 (cyc/mm); the meridional curve T3 and sagittal curve S3 correspond to the cut-off frequency of 15.00 (cyc/mm); the meridional curve T4 and sagittal curve S4 correspond to the cut-off frequency of 20.00 (cyc/mm); the meridional curve T5 and sagittal curve S5 correspond to the cut-off frequency of 30.00 (cyc/mm); the meridional curve T6 and sagittal curve S6 correspond to the cut-off frequency of 42.00 (cyc/mm).

As shown in FIG. 4, the optical system provided by the present application at room temperature has an MTF of cut-off frequency of 42.00 cyc/mm greater than 0.2 at all fields of view all the time, that is, the MTF of cut-off frequency of 42.00 cyc/mm is greater than the target requirement at all fields of view all the time, which indicates that image quality of the optical system at room temperature is good. And the MTF at the cut-off frequency of 42.00 cyc/mm at 0.8 FOV will not change with the FOV getting larger, thus at room temperature the clarity and uniformity of imaging for the optical system at 0.8 FOV are all good. Moreover, for the meridional curve T and the sagittal curve S at the same cut-off frequency, the deviation between the two kinds of curve is small, which indicates that the optical system has an excellent dispersion control of imaging at room temperature. Moreover, the deviation between the value of MTF of each curve at the smallest FOV and the value of MTF of each curve at the biggest FOV is smaller, which indicates that the optical system has an excellent curvature radius of control at room temperature.

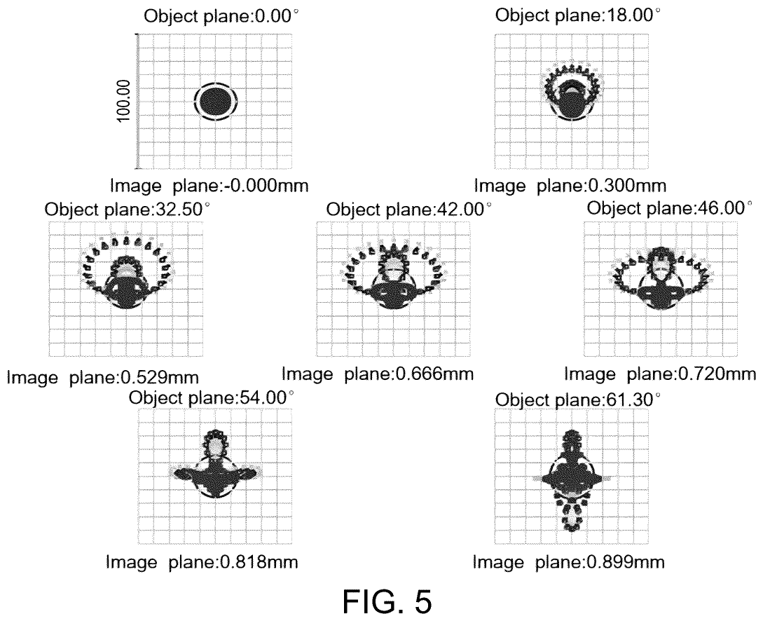

FIG. 5 shows a spot diagram at room temperature of the optical system working at the far-infrared waveband in one embodiment provided by the present application. FIG. 5 shows spot diagrams of imaging of wavelengths at 8 μm, 10 μm and 12 μm. As can be seen from FIG. 5, the optical system provided in this embodiment has dense imaging spots at wavelengths of 8 μm, 10 μm and 12 μm, thus indicating that the optical system has excellent imaging quality at the waveband from 8 μm to 12 μm at room temperature.

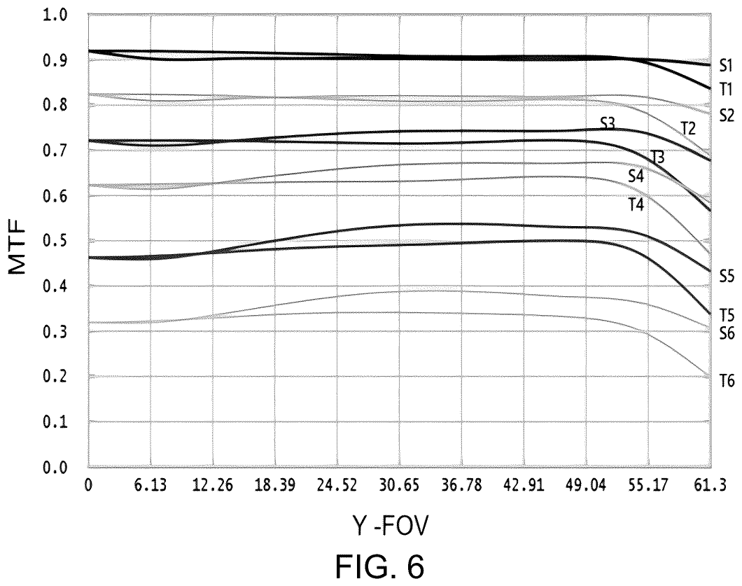

FIG. 6 shows a curve diagram at the temperature of −40° C. between the MTF and field of view of the optical system working at the far-infrared waveband in embodiment 1 provided by the present application. Similarly, the meaning of the horizontal and vertical axis and the meaning of each curve are the same as the description of FIG. 4, the meaning of the horizontal and vertical axis and each curve will not be repeated here.

From FIG. 6 can be seen, the optical system provided by the present application, the MTF at a cut-off frequency of 42 cyc/mm is greater than 0.2, that is, the MTF is greater than the target requirement of 0.15, which indicates that image quality of the optical system at the temperature of −40° C. is good. Similarly, other performance indices reflected in the optical system in FIG. 4 are the same as the performance indices in FIG. 6, which will not repeat here.

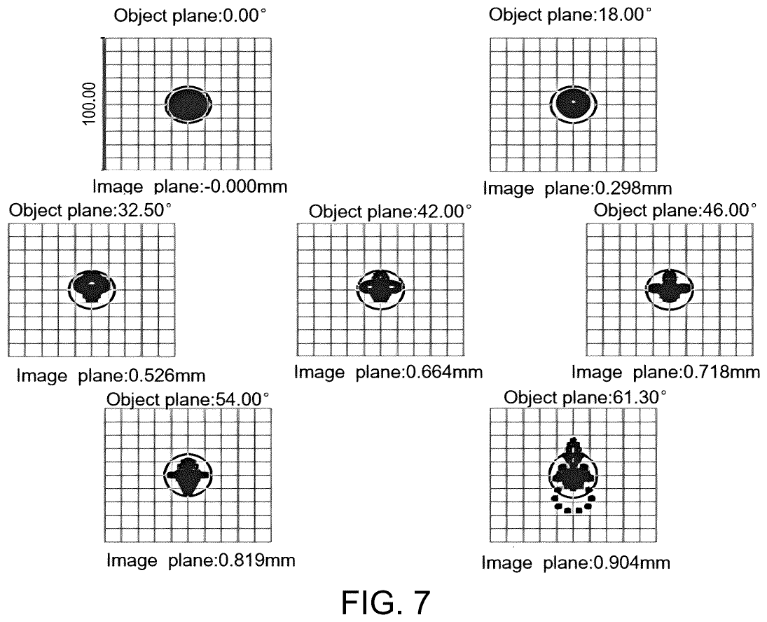

FIG. 7 shows a spot diagram of imaging at a temperature of −40° C. in Embodiment 1. FIG. 7 shows spot diagrams of imaging at the wavelengths of 8 μm, 10 μm and 12 μm. As shown in FIG. 7, in the optical system provided by the present embodiment, the imaging spots are denser at the wavelengths of 8 μm, 10 μm and 12 μm. Thus, the optical system at a temperature of −40° C. has excellent imaging quality.

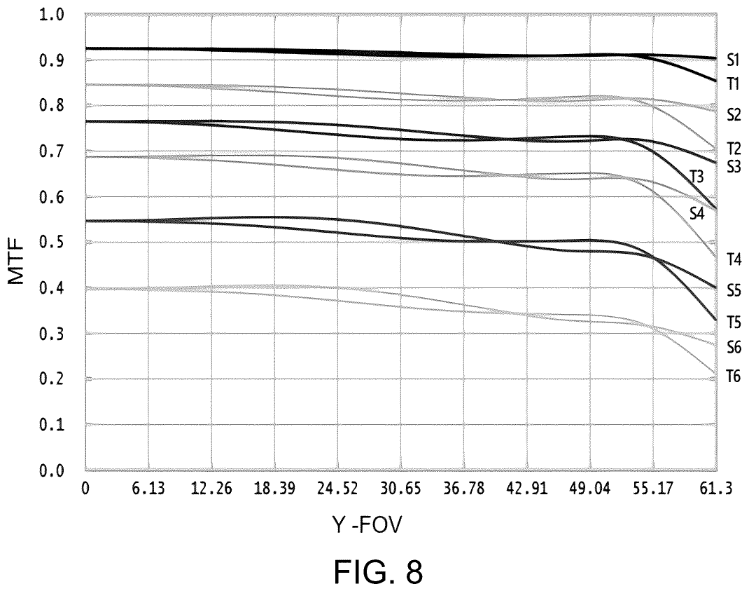

FIG. 8 shows a curve diagram at the temperature of 80° C. between the MTF and field of view of the optical system working at the far-infrared waveband in one embodiment provided by the present application. Similarly, the meaning of the horizontal and vertical axis and the meaning of each curve are the same as the description of FIG. 4, the meaning of the horizontal and vertical axis and each curve will not be repeated here.

It can be seen in FIG. 8, MTF at a cut-off frequency of 42.00 cyc/mm is greater than 0.2 at all fields of view all the time. That is, MTF is greater than the target requirement of 0.15, which indicates that the optical system at a temperature of 80° C. has good imaging quality at all fields of view. Similarly, the meaning of the horizontal and vertical axis and the meaning of each curve are the same as the description of FIG. 4, the meaning of the horizontal and vertical axis and each curve in FIG. 8 will not be repeated here.

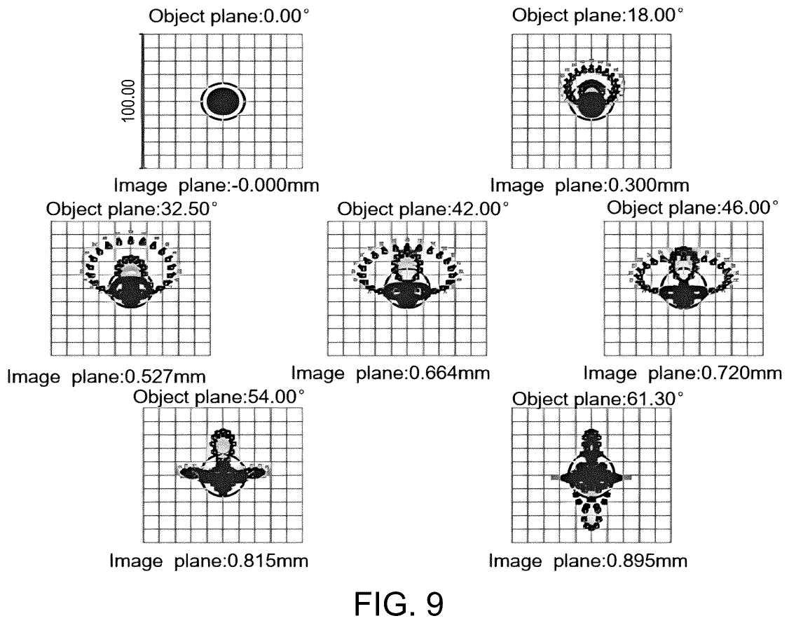

FIG. 9 shows a spot diagram of the optical system at a temperature of 80° C. provided by the present application. FIG. 9 shows spot diagrams of imaging of wavelengths at 8 μm, 10 μm and 12 μm. As can be seen from FIG. 9, the optical system provided in this embodiment has dense imaging spots at wavelengths of 8 μm, 10 μm and 12 μm, thus indicating that the optical system has excellent imaging quality at the waveband from 8 μm to 12 μm at room temperature. From FIG. 4 to FIG. 9, the optical system provided by the present application at the temperature from −40° C. to 80° C. keeps good image quality at the wavelength of 8-12 μm all the time, which indicates that the optical system has fully realized the athermalization.

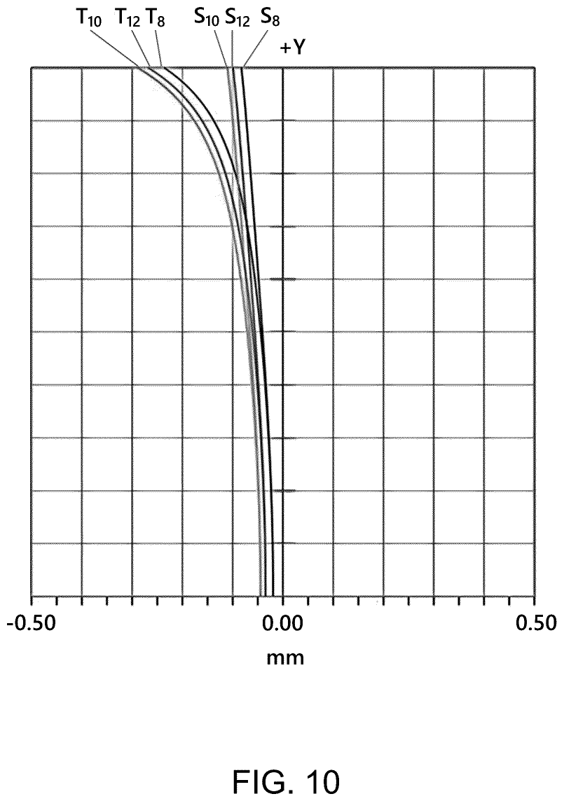

FIG. 10 shows a field curvature in Embodiment 1. In FIG. 10, the horizontal axis represents the offset between the actual focal point and the image plane, and the unit of the offset is expressed in mm; The vertical axis represents the normalization field of view along the forward of Y-axis. In FIG. 10, T₈ represents the curve of field curvature in meridional direction at wavelength of 8 μm; and S₈ represents the curve of field curvature in sagittal direction at wavelength of 8 μm; T₁₀ represents the curve of field curvature in meridional direction at wavelength of 10 μm; and S₁₀ represents the curve of field curvature in sagittal direction at wavelength of 10 μm; T₁₂ represents the curve of field curvature in meridional direction at wavelength of 8 μm; and S₁₂ represents the curve of field curvature in sagittal direction at wavelength of 12 μm.

It can be seen from FIG. 10, at the wavelengths from 8-12 μm, the field curvature is less than 0.30 mm, thus the field curvature of the optical system is smaller.

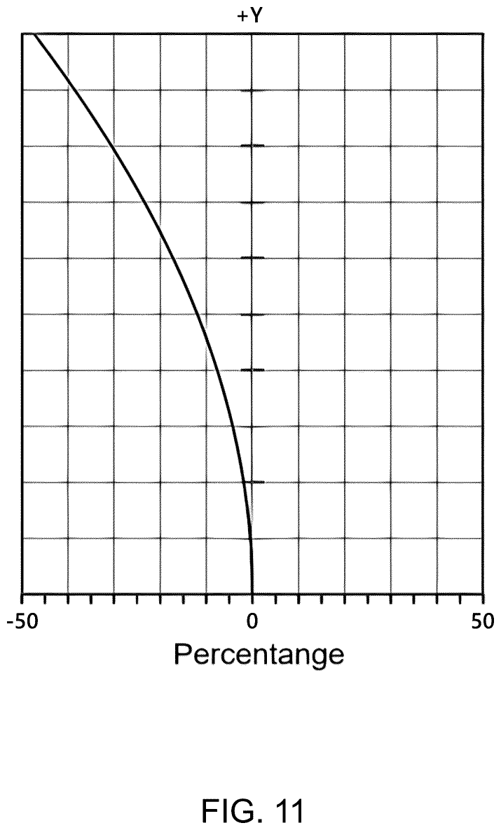

It can be seen from FIG. 11, at the wavelengths of 8-12 μm, the distortion of the optical system is less than 50%, which satisfies the distortion of target requirements of the optical system.

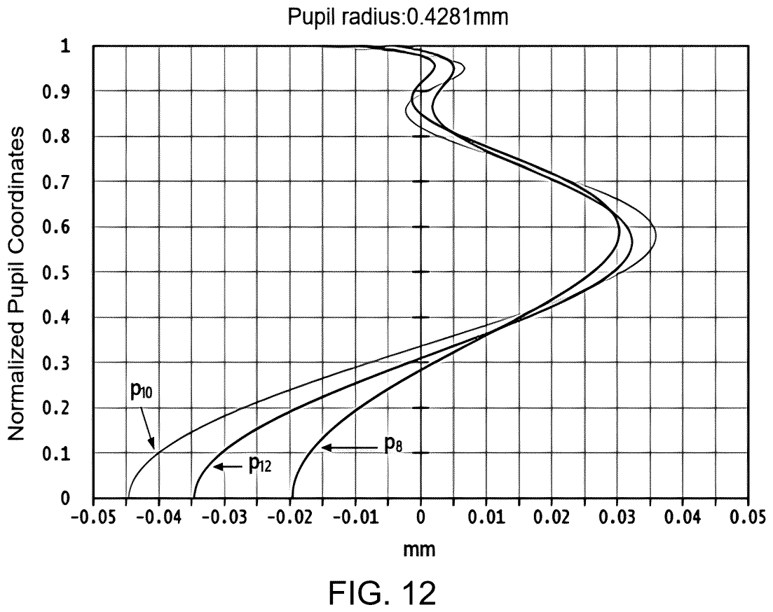

FIG. 12 shows a wavefront aberration diagram in the axial direction of the optical system provided by embodiment 1. The horizontal axis represents the value of spherical aberration, and the unit of the spherical aberration is expressed in mm; the vertical axis represents the normalized coordinate of pupils and the coordinate of pupils doesn't have unit. In FIG. 12, P₈ represents the axial curve of wavefront aberration at the wavelength of 8 μm, and P₁₀ represents the axial curve of wavefront aberration at the wavelength of 10 μm, and P₁₂ represents the axial curve of wavefront aberration at the wavelength of 12 μm.

It can be seen from FIG. 12, at each wavelength from 8-12 μm, the axial wavefront aberration of the optical system is less than 0.045 mm, thus the spherical aberration of the optical system is smaller; and the three axial aberration curves of P₈, P₁₀ and P₁₂ are relatively dense, which indicates that the chromatic aberration is smaller.

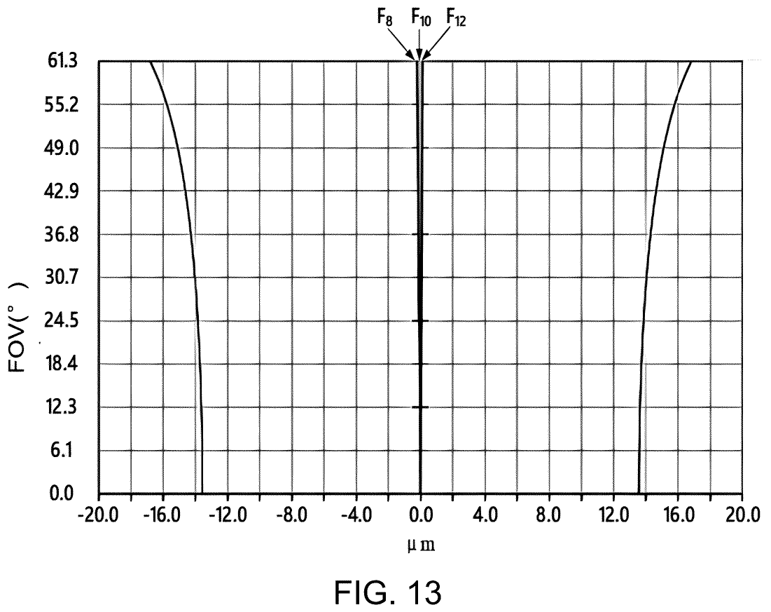

FIG. 13 shows a chromatic aberration diagram in the vertical axis direction of the optical system working at the far-infrared waveband in one embodiment provided by the present application. The horizontal axis in FIG. 13 represents the deviation between the position of the image point of central working waveband and the image point of other wavelengths of the working waveband, and the unit of deviation is expressed in μm; the vertical axis represents the FOV and the unit of FOV is expressed in degrees. In FIG. 13, the two curves on the outermost sides describe the diameter range of Airy disk; the three curves from the left to right are the chromatic aberration curve F₈ at the wavelength of 8 μm in the direction of vertical axis, the chromatic aberration curve F₁₀ at the wavelength of 10 μm in the direction of vertical axis, and the chromatic aberration curve F₁₂ at the wavelength of 12 μm in the direction of vertical axis.

It can be seen from FIG. 13, in the wavelength of 8-12 μm, the chromatic aberration in the direction of vertical axis is located at the diameter range of Airy disk, and still has a lot of margins, thus the chromatic aberration has been well compensated.

### Embodiment 2

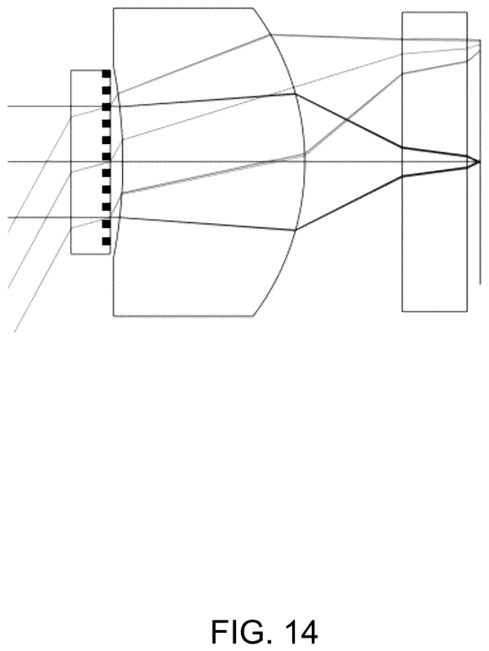

FIG. 14 shows a schematic diagram of the architectural layout of the optical system and the optical camera working at the far-infrared waveband in Embodiment 2. As shown in FIG. 14, in Embodiment 2, the optical system working at a far-infrared waveband, including 4 optical elements, the 4 optical elements being, along the optical axis in order from an object side to an image side: a metalens, an aperture slot, a refractive lens and an optical window glass. And the aperture slot is set on the image-side surface of the metalens.

TABLE 4
The various system parameters
of the optical system

| System Parameters | Data | |
|---|---|---|
| TTL | 3.15 | mm |
| FOV | 122.6° | |
| F number | 1.1 | |
| Effective focal length | 0.90 | mm |
| Working waveband | 8~12 | μm |

As can be seen from Table 4, the optical system provided by the present application works at the waveband from 8 μm to 12 μm; the optical system has a TTL of 3.15 mm, and the TTL is less than that in the target requirement of 3.8 mm, which can fully satisfy the requirement of miniaturization. The F number of the optical system is 1.1 and the F number is equal to the target requirement, which can fully satisfy the requirements of the optical system for light intake.

Along the direction from the object side to the image side, each surface of the optical system is numbered. After summarizing the parameters of each surface, Table 5 is obtained as shown below.

TABLE 5
parameters of each surface of the
optical system in Embodiment 2

| Surface | | Curvature | | |
|---|---|---|---|---|
| number | Type of surfaces | radius | Thickness | Material |
| 1 | Object plane | Infinite | — | — |
| 2 | Spherical plane | Infinite | 0.30 mm | Silicon |
| 3 | Structural | Infinite | 0.10 mm | — |
| | surface | | | |
| | (Aperture slot) | | | |
| 4 | Spherical plane | −3.82 mm | 1.40 mm | Silicon |
| 5 | Spherical plane | −1.97 mm | 0.75 mm | — |
| 6 | Spherical plane | Infinite | 0.50 mm | Silicon |
| 7 | Spherical plane | Infinite | 0.10 mm | — |
| 8 | Image plane | Infinite | — | — |

The explanation of Table 5 refers to the explanation of Table 3, and will not repeat here.

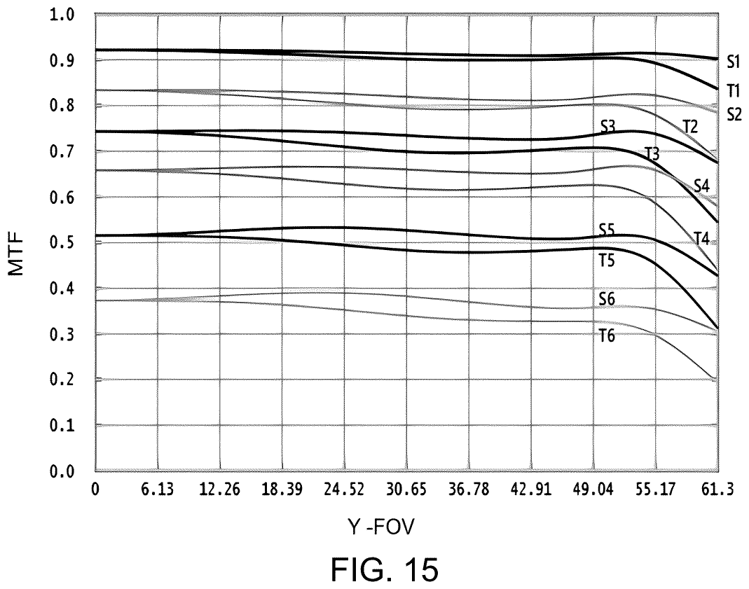

FIG. 15 shows a curve diagram at room temperature between the MTF and field of view of the optical system working at the far-infrared waveband in Embodiment 2 provided by the present application. Similarly, for the meaning of the horizontal and vertical axis of FIG. 4 and the meaning of each curve, the meaning of the horizontal and vertical axis of FIG. 15 and each curve will not be repeated here.

As shown in FIG. 15, the optical system provided by the present application at room temperature has an MTF of cut-off frequency of 42.00 cyc/mm greater than 0.19 at all fields of view all the time, that is, the MTF of cut-off frequency of 42.00 cyc/mm is greater than the target requirement of 0.15 at all fields of view all the time, which indicates that image quality of the optical system at room temperature is good. Similarly, for the interpretation of other aspects of the performance index of the optical system reflected in FIG. 4, the other aspects of the performance index of the optical system reflected in FIG. 15 will not be repeated here.

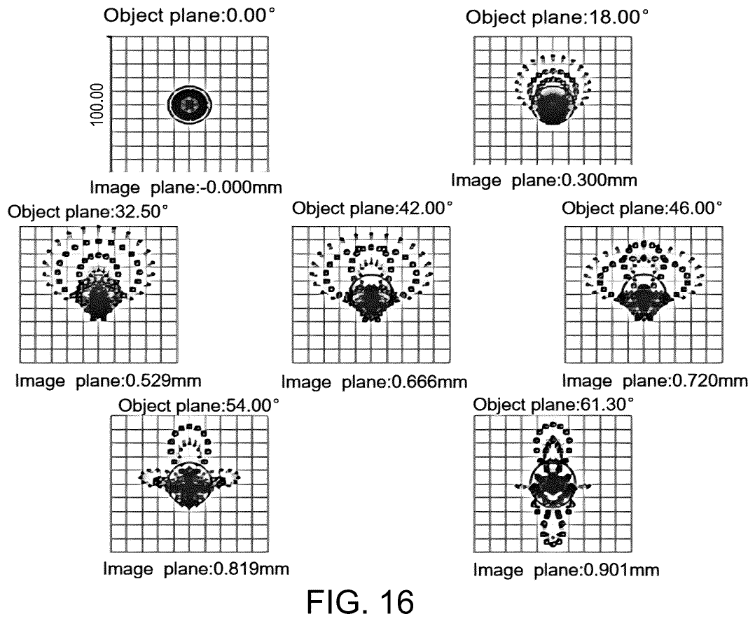

FIG. 16 shows a spot diagram at room temperature of the optical system working at the far-infrared waveband in Embodiment 2. FIG. 16 shows spot diagrams of imaging of wavelengths at 8 μm, 10 μm and 12 μm. As can be seen from FIG. 5, the optical system provided in this embodiment has dense imaging spots at wavelengths of 8 μm, 10 μm and 12 μm, thus indicating that the optical system has excellent imaging quality at the waveband from 8 μm to 12 μm at room temperature.

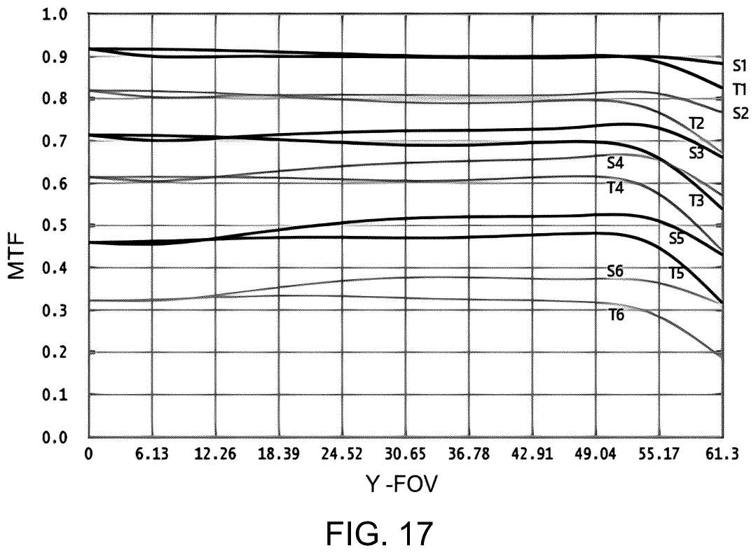

FIG. 17 shows a curve diagram at the temperature of −40° C. between the MTF and field of view of the optical system working at the far-infrared waveband in Embodiment 2 provided by the present application. Similarly, the meaning of the horizontal and vertical axis and the meaning of each curve are the same as the description of FIG. 4, the meaning of the horizontal and vertical axis and each curve in FIG. 17 will not be repeated here.

From FIG. 17 can be seen, the optical system provided by the present application, the MTF at a cut-off frequency of 42 cyc/mm is greater than 0.18, that is, the MTF is greater than the target requirement of 0.15, which indicates that image quality of the optical system at the temperature of −40° C. is good. Similarly, other performance indices reflected in the optical system in FIG. 17 are the same as the performance indices in FIG. 4, which will not repeat here.

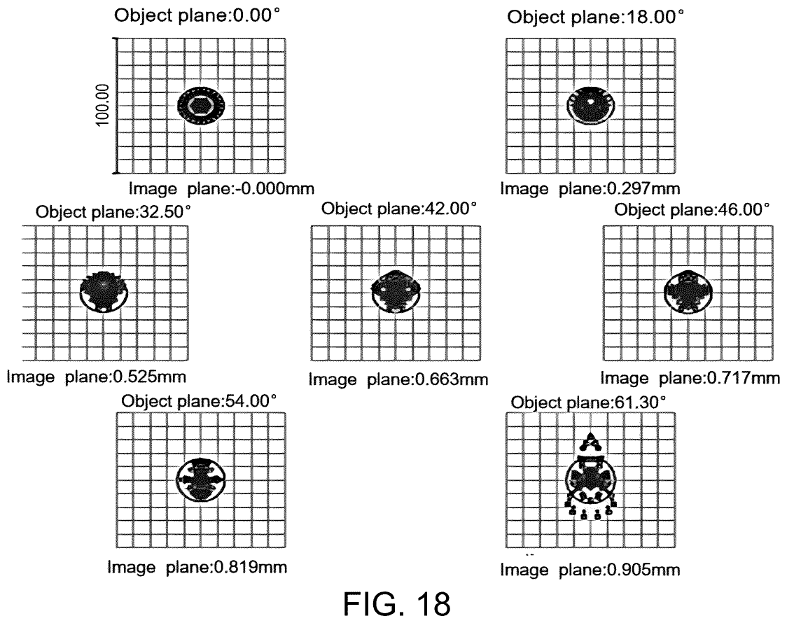

FIG. 18 shows a spot diagram of imaging at temperature of −40° C. in Embodiment 2. FIG. 18 shows spot diagrams of imaging at the wavelengths of 8 μm, 10 μm and 12 μm. As shown in FIG. 18, in the optical system provided by the present embodiment, the imaging spots are denser at the wavelengths of 8 μm, 10 μm and 12 μm. Thus, the optical system at temperature of −40° C. has excellent imaging quality.

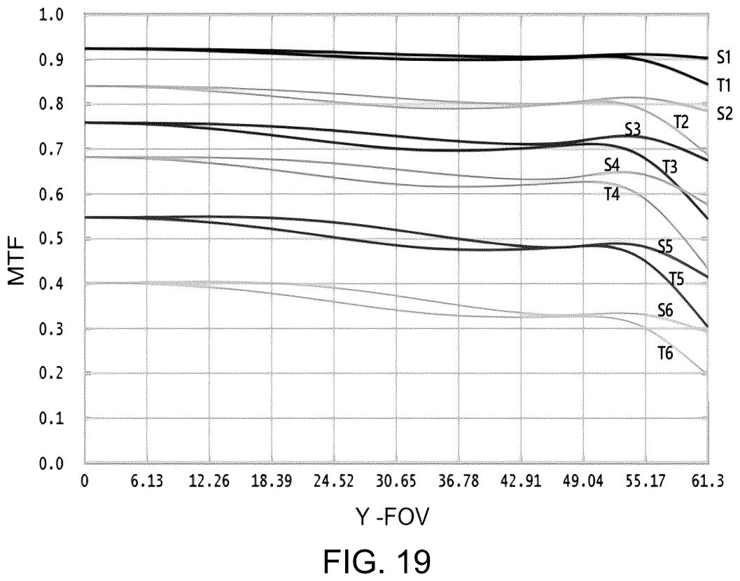

FIG. 19 shows a curve diagram at the temperature of 80° C. between the MTF and field of view of the optical system working at the far-infrared waveband in Embodiment 2. Similarly, the meaning of the horizontal and vertical axis and the meaning of each curve are the same as the description of FIG. 19, the meaning of the horizontal and vertical axis and each curve will not be repeated here.

It can be seen in FIG. 19, MTF at a cut-off frequency of 42.00 cyc/mm is greater than 0.19 at all fields of view all the time. That is, MTF is greater than the target requirement of 0.15, which indicates that the optical system at temperature of 80° C. has good imaging quality at all fields of view. Similarly, the meaning of the horizontal and vertical axis and the meaning of each curve are the same as the description of FIG. 4, the meaning of the horizontal and vertical axis and each curve in FIG. 19 will not be repeated here.

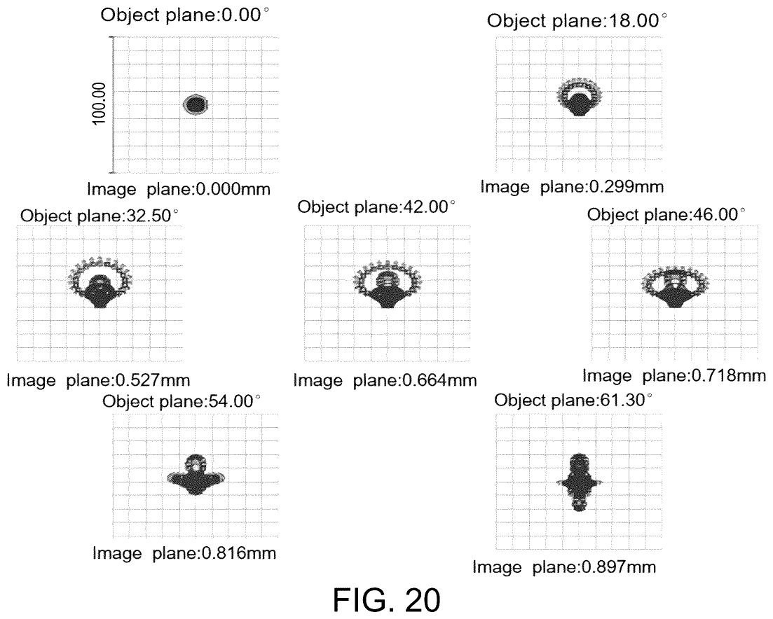

FIG. 20 shows a spot diagram of the optical system at temperature of 80° C. provided by the present application. FIG. 20 shows spot diagrams of imaging of wavelengths at 8 μm, 10 μm and 12 μm. As can be seen from FIG. 20, the optical system provided in this embodiment has dense imaging spots at wavelengths of 8 μm, 10 μm and 12 μm, thus indicating that the optical system has excellent imaging quality at the waveband from 8 μm to 12 μm at room temperature.

From FIG. 15 to FIG. 20, the optical system provided by the present application at the temperature from −40° C. to 80° C. keeps good image quality at the wavelength of 8-12 μm all the time, which indicates that the optical system has fully realized the athermalization.

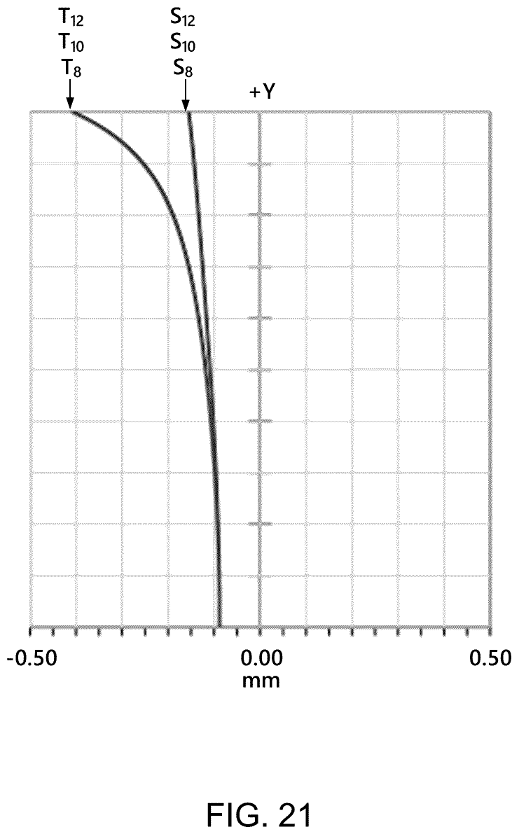

FIG. 21 shows a field curvature in Embodiment 2. Similarly, the meaning of the curve of field curvature and the meaning of each curve are the same as the description of FIG. 10, the meaning of each curve will not be repeated here.

It can be seen from FIG. 21, at the wavelengths from 8-12 μm, the field curvature is less than 0.35 mm, thus the field curvature of the optical system is smaller.

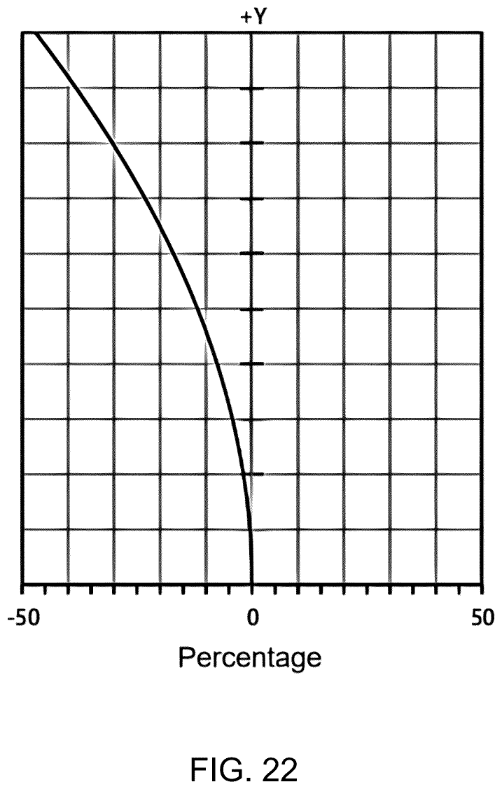

FIG. 22 shows a distortion diagram of the optical system. Similarly, the meaning of the curve of distortion and the meaning of each curve are the same as the description of FIG. 10, the meaning of each curve will not be repeated here.

It can be seen from FIG. 22, at the wavelengths of 8-12 μm, the distortion of the optical system is less than 50%, which satisfies the distortion of target requirements of the optical system.

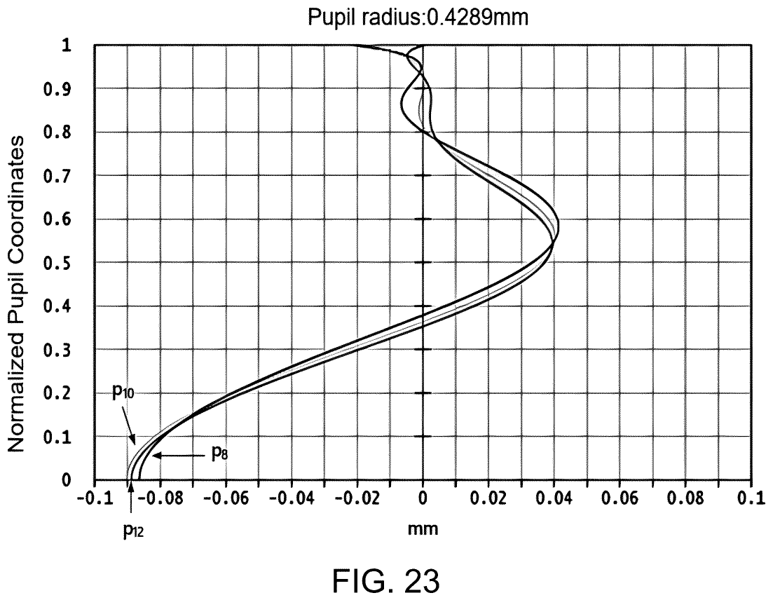

FIG. 23 shows a wavefront aberration diagram in the axial direction of the optical system provided by embodiment 2. The horizontal axis represents the value of spherical aberration, and the unit of the spherical aberration is expressed in mm; the vertical axis represents the coordinate of pupils and coordinate of pupils doesn't have unit. In FIG. 23, P₈ represents the axial curve of wavefront aberration at the wavelength of 8 μm, and P₁₀ represents the axial curve of wavefront aberration at the wavelength of 10 μm, and P₁₂ represents the axial curve of wavefront aberration at the wavelength of 12 μm.

It can be seen from FIG. 23, at each wavelength from 8-12 μm, the axial wavefront aberration of the optical system is less than 0.09 mm, thus the spherical aberration of the optical system is smaller; and the three axial aberration curves of P₈, P₁₀ and P₁₂ are relatively dense, which indicates that the chromatic aberration is smaller.

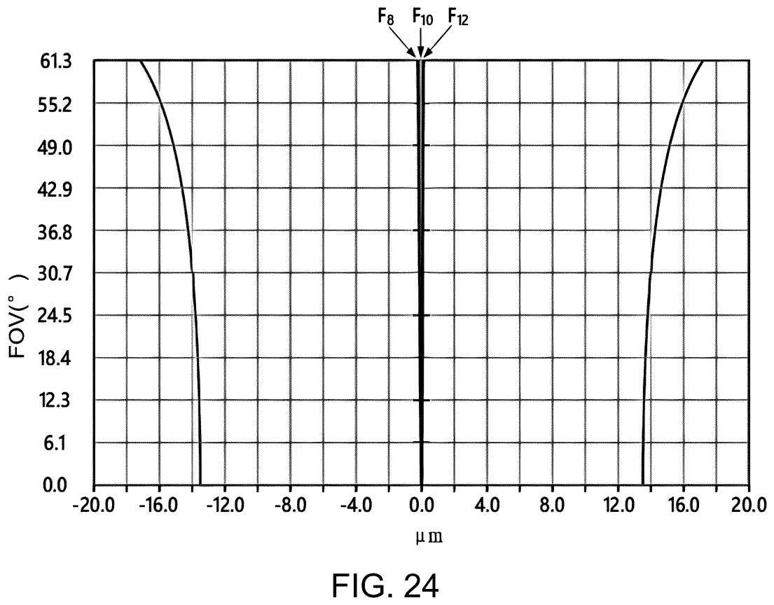

FIG. 24 shows a chromatic aberration diagram in the vertical axis direction of the optical system working at the far-infrared waveband in one embodiment provided by the present application. Similarly, the meaning of the horizontal and vertical axis and the meaning of each curve are the same as the description of FIG. 4, the meaning of the horizontal and vertical axis and each curve in FIG. 24 will not be repeated here.

It can be seen from FIG. 24, in the wavelength of 8-12 μm, the chromatic aberration in the direction of vertical axis is located at the diameter range of Airy disk, and still has a lot of margins, thus the chromatic aberration has been well compensated.

### Embodiment 3

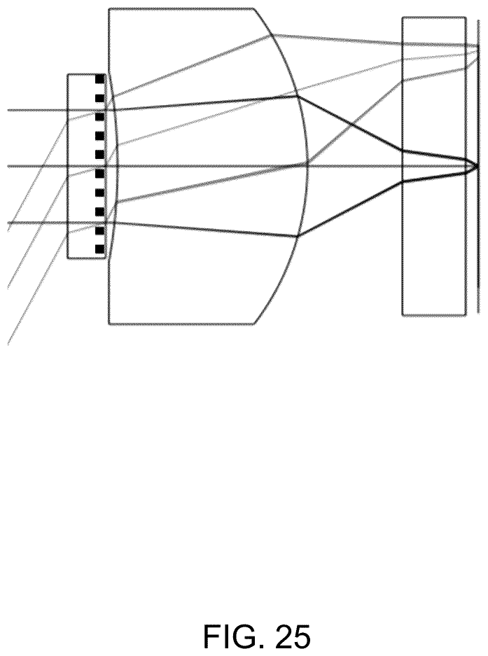

FIG. 25 shows a schematic diagram of the architectural layout of the optical system and the optical camera working at the far-infrared waveband in Embodiment 3. As shown in FIG. 25, in Embodiment 3, the optical system working at a far-infrared waveband, including 4 optical elements, the 4 optical elements being, along the optical axis in order from an object side to an image side: a metalens, an aperture slot, a refractive lens and an optical window glass. The aperture slot is set on the image-side surface of the metalens.

TABLE 6
The various system parameters
of the optical system

| System Parameters | Data | |
|---|---|---|
| TTL | 3.24 | mm |
| FOV | 122.7° | |
| F number | 1.08 | |
| Effective focal length | 0.92 | mm |
| Working waveband | 8~12 | μm |

As can be seen from Table 6, the optical system provided by the present application works at the waveband from 8 μm to 12 μm; the optical system has a TTL of 3.24 mm, and the TTL is less than that in the target requirement of 3.8 mm, which can fully satisfy the requirement of miniaturization. The F number of the optical system is 1.08 and the F number is less than the target requirement of 1.1, which can fully satisfy the requirements of the optical system for light intake.

Along the direction from the object side to the image side, each surface of the optical system is numbered. After summarizing the parameters of each surface, Table 7 is obtained as shown below.

TABLE 7
parameters of each surface of the
optical system in Embodiment 3

| Surface | | Curvature | | |
|---|---|---|---|---|
| number | Type of surfaces | radius | Thickness | Material |
| 1 | Object plane | Infinite | — | — |
| 2 | Spherical plane | Infinite | 0.30 mm | Silicon |
| 3 | Structural | Infinite | 0.09 mm | — |
| | surface | | | |
| | (Aperture slot) | | | |
| 4 | Spherical plane | −4.10 mm | 1.50 mm | Silicon |
| 5 | Spherical plane | −2.02 mm | 0.75 mm | — |
| 6 | Spherical plane | Infinite | 0.50 mm | Silicon |
| 7 | Spherical plane | Infinite | 0.10 mm | — |
| 8 | Image plane | Infinite | — | — |

The explanation of Table 7 refers to the explanation of Table 3, and will not repeat here.

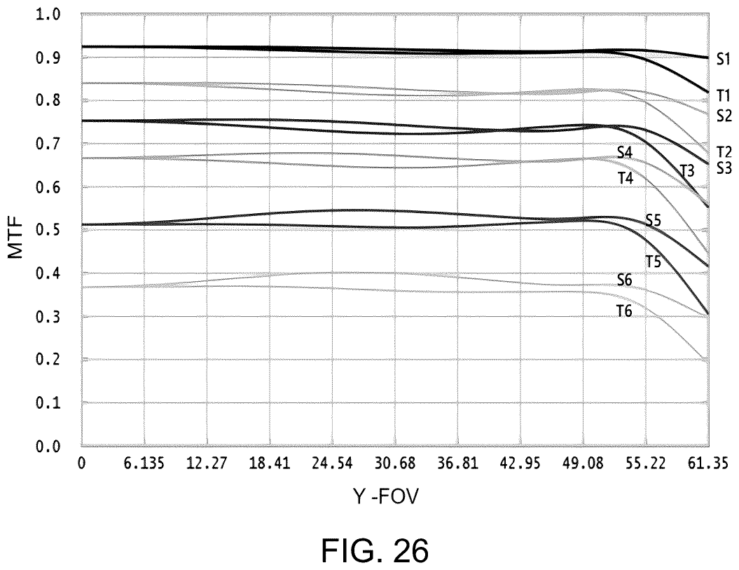

FIG. 26 shows a curve diagram at room temperature between the MTF and field of view of the optical system working at the far-infrared waveband in Embodiment 3 provided by the present application. Similarly, for the meaning of the horizontal and vertical axis of FIG. 4 and the meaning of each curve, the meaning of the horizontal and vertical axis of FIG. 26 and each curve will not be repeated here.

As shown in FIG. 26, the optical system provided by the present application at room temperature has an MTF of 0.19 at a cut-off frequency of 42.00 cyc/mm greater than 0.15 at all fields of view all the time, that is, the MTF of cut-off frequency of 42.00 cyc/mm is greater than the target requirement of 0.15 at all fields of view all the time, which indicates that image quality of the optical system at room temperature is good. Similarly, for the interpretation of other aspects of the performance index of the optical system reflected in FIG. 4, the other aspects of the performance index of the optical system reflected in FIG. 26 will not be repeated here.

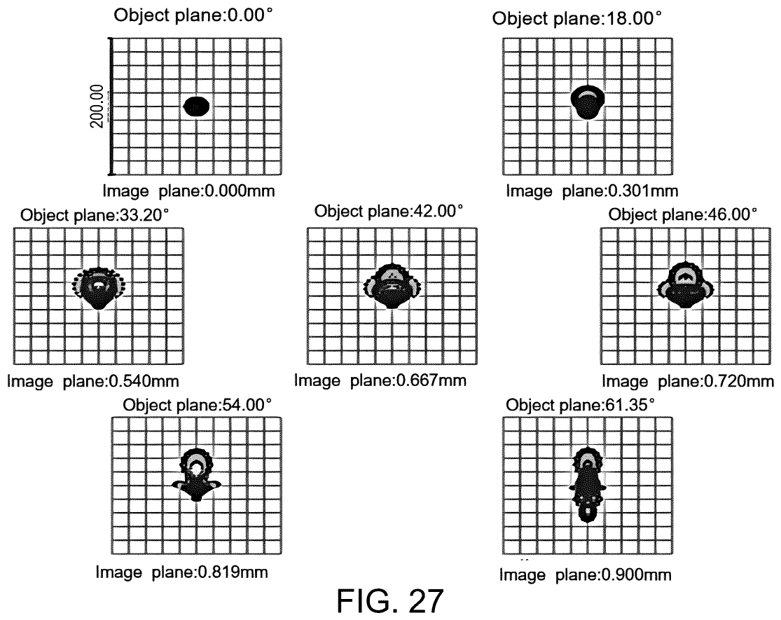

FIG. 27 shows a spot diagram at room temperature of the optical system working at the far-infrared waveband in Embodiment 3. FIG. 27 shows spot diagrams of imaging of wavelengths at 8 μm, 10 μm and 12 μm. As can be seen from FIG. 27, the optical system provided in this embodiment has dense imaging spots at wavelengths of 8 μm, 10 μm and 12 μm, thus indicating that the optical system has excellent imaging quality at the waveband from 8 μm to 12 μm at room temperature.

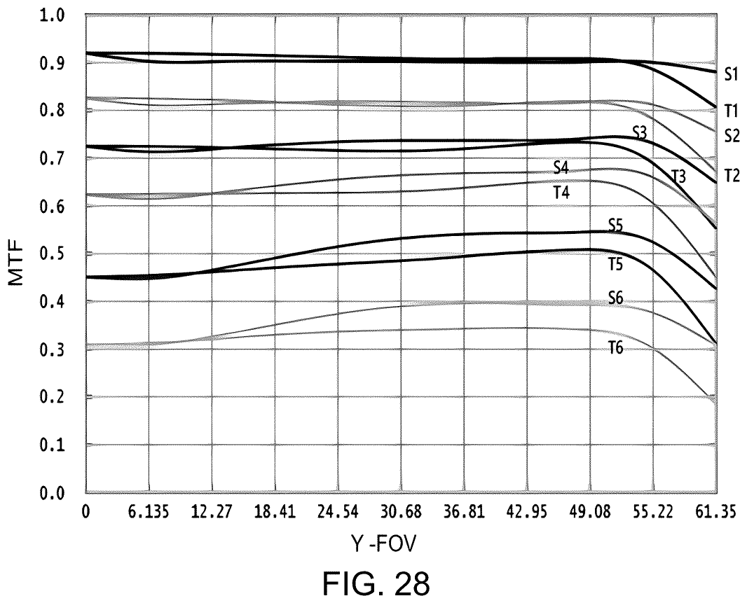

FIG. 28 shows a curve diagram at the temperature of −40° C. between the MTF and field of view of the optical system working at the far-infrared waveband in Embodiment 3 provided by the present application. Similarly, the meaning of the horizontal and vertical axis and the meaning of each curve are the same as the description of FIG. 4, the meaning of the horizontal and vertical axis and each curve in FIG. 28 will not be repeated here.

From FIG. 28 can be seen, the optical system provided by the present application, the MTF at a cut-off frequency of 42 cyc/mm is greater than 0.18, that is, the MTF is greater than the target requirement of 0.15, which indicates that image quality of the optical system at the temperature of −40° C. is good. Similarly, other performance indices reflected in the optical system in FIG. 28 are the same as the performance indices in FIG. 4, which will not repeat here.

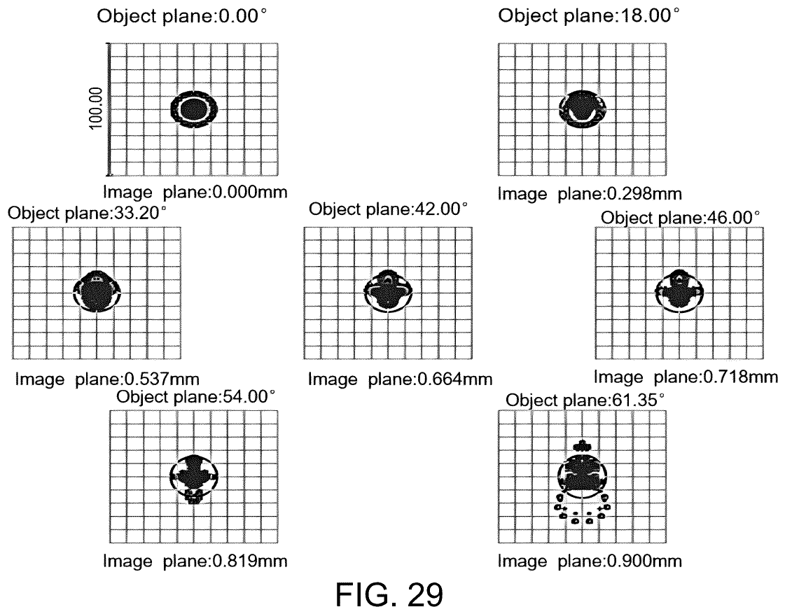

FIG. 29 shows a spot diagram of imaging at temperature of −40° C. in Embodiment 3. FIG. 29 shows spot diagrams of imaging at the wavelengths of 8 μm, 10 μm and 12 μm. As shown in FIG. 29, in the optical system provided by the present embodiment, the imaging spots are denser at the wavelengths of 8 μm, 10 μm and 12 μm. Thus, the optical system at temperature of −40° C. has excellent imaging quality.

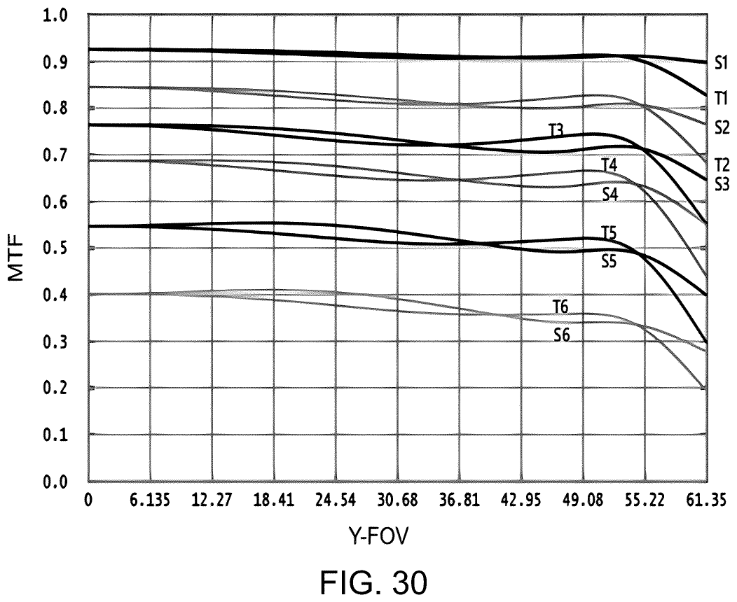

FIG. 30 shows a curve diagram at the temperature of 80° C. between the MTF and field of view of the optical system working at the far-infrared waveband in Embodiment 3. Similarly, the meaning of the horizontal and vertical axis and the meaning of each curve are the same as the description of FIG. 30, the meaning of the horizontal and vertical axis and each curve will not be repeated here.

It can be seen in FIG. 30, MTF at a cut-off frequency of 42.00 cyc/mm is greater than 0.19 at all fields of view all the time. That is, MTF is greater than the target requirement of 0.15, which indicates that the optical system at temperature of 80° C. has good imaging quality at all fields of view. Similarly, the meaning of the horizontal and vertical axis and the meaning of each curve are the same as the description of FIG. 4, the meaning of the horizontal and vertical axis and each curve in FIG. 30 will not be repeated here.

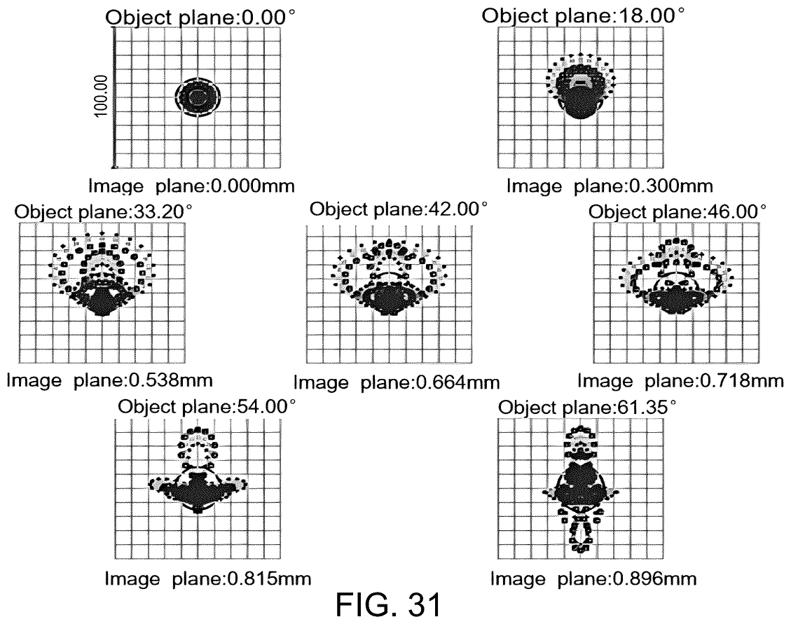

FIG. 31 shows a spot diagram of the optical system at temperature of 80° C. provided by the present application. FIG. 31 shows spot diagrams of imaging of wavelengths at 8 μm, 10 μm and 12 μm. As can be seen from FIG. 31, the optical system provided in this embodiment has dense imaging spots at wavelengths of 8 μm, 10 μm and 12 μm, thus indicating that the optical system has excellent imaging quality at the waveband from 8 μm to 12 μm at room temperature. From FIG. 26 to FIG. 31, the optical system provided by the present application at the temperature from −40° C. to 80° C. keeps good image quality at the wavelength of 8-12 μm all the time, which indicates that the optical system has fully realized the athermalization.

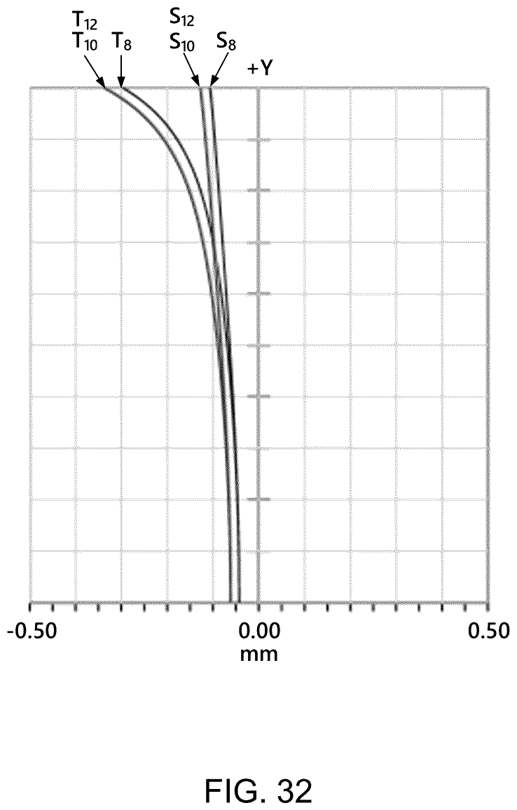

FIG. 32 shows a field curvature in Embodiment 3. Similarly, the meaning of the curve of field curvature and the meaning of each curve are the same as the description of FIG. 32, the meaning of each curve will not be repeated here.

It can be seen from FIG. 32, at the wavelengths from 8-12 μm, the field curvature is less than 0.30 mm, thus the field curvature of the optical system is smaller.

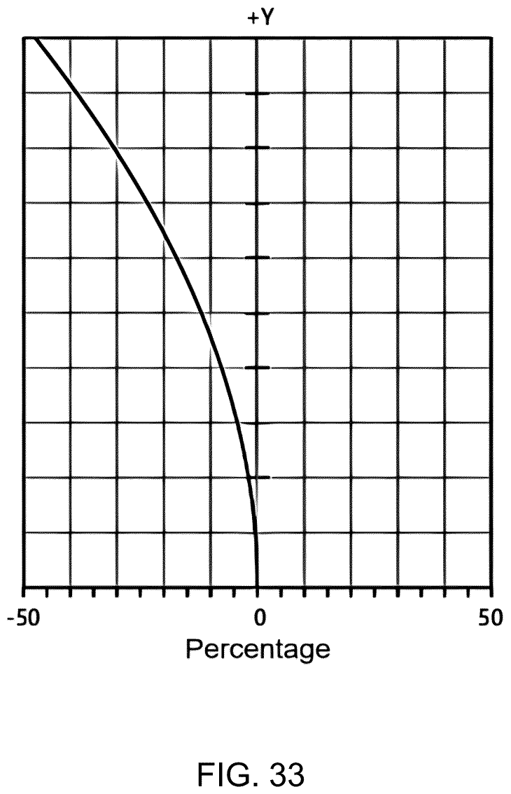

FIG. 33 shows a distortion diagram of the optical system. Similarly, the meaning of the curve of distortion and the meaning of each curve are the same as the description of FIG. 11, the meaning of each curve will not be repeated here.

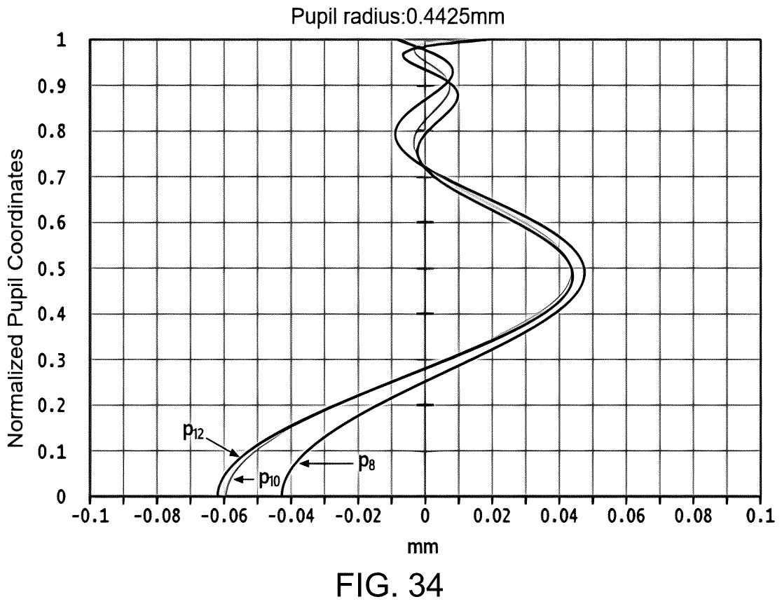

It can be seen from FIG. 34, at the wavelengths of 8-12 μm, the distortion of the optical system is less than 50%, which satisfies the distortion of target requirements of the optical system.

FIG. 34 shows a wavefront aberration diagram in the axial direction of the optical system provided by embodiment 3. Similarly, the meaning of the horizontal and vertical axis and the meaning of each curve are the same as the description of FIG. 12, the meaning of each curve will not be repeated here.

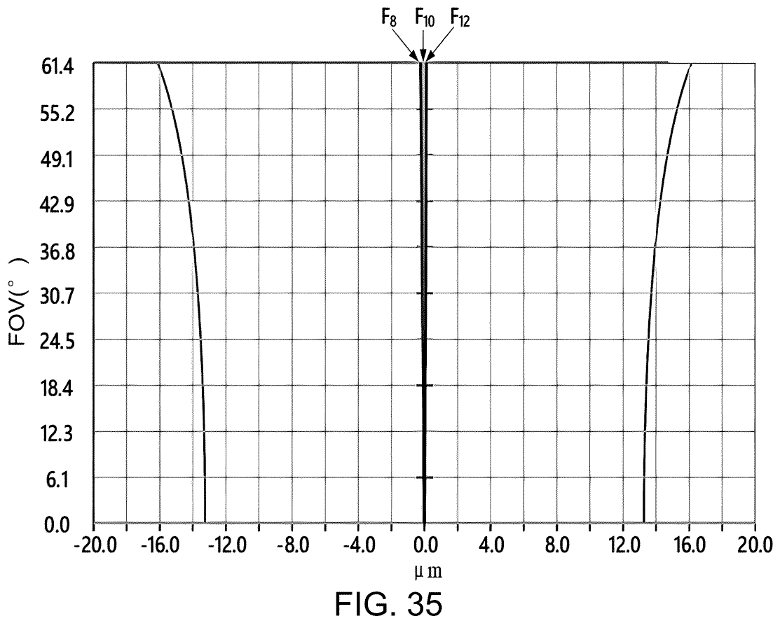

It can be seen from FIG. 35, at each wavelength from 8-12 μm, the axial wavefront aberration of the optical system is less than 0.07 mm, thus the spherical aberration of the optical system is smaller; and the three axial aberration curves of P₈, P₁₀ and P₁₂ are relatively dense, which indicates that the chromatic aberration is smaller.

FIG. 35 shows a chromatic aberration diagram in the vertical axis direction of the optical system working at the far-infrared waveband in one embodiment provided by the present application. Similarly, the meaning of the horizontal and vertical axis and the meaning of each curve are the same as the description of FIG. 4, the meaning of the horizontal and vertical axis and each curve in FIG. 35 will not be repeated here.

It can be seen from FIG. 35, in the wavelength of 8-12 μm, the chromatic aberration in the direction of vertical axis is located at the diameter range of Airy disk, and still has a lot of margins, thus the chromatic aberration has been well compensated.

### Embodiment 4

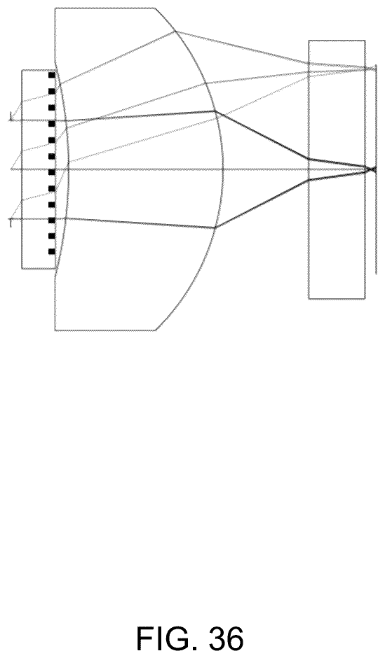

FIG. 36 shows a schematic diagram of the architectural layout of the optical system and the optical camera working at the far-infrared waveband in Embodiment 4. As shown in FIG. 36, in Embodiment 4, the optical system working at a far-infrared waveband, including 4 optical elements, the 4 optical elements being, along the optical axis in order from an object side to an image side: a metalens, an aperture slot, a refractive lens and an optical window glass. The aperture slot is set on the image-side surface of the metalens.

TABLE 8
The various system parameters
of the optical system

| System Parameters | Data | |
|---|---|---|
| TTL | 3.24 | mm |
| FOV | 118° | |
| F number | 1.09 | |
| Effective focal length | 0.92 | mm |
| Working waveband | 8~12 | μm |

As can be seen from Table 8, the optical system provided by the present application works at the waveband from 8 μm to 12 μm; the optical system has a TTL of 3.24 mm, and the TTL is less than that in the target requirement of 3.8 mm, which can fully satisfy the requirement of miniaturization. The F number of the optical system is 1.09 and the F number is less than the target requirement of 1.1, which can fully satisfy the requirements of the optical system for light intake.

Along the direction from the object side to the image side, each surface of the optical system is numbered. After summarizing the parameters of each surface, Table 7 is obtained as shown below.

TABLE 9
parameters of each surface of the
optical system in Embodiment 4

| Surface | | Curvature | | |
|---|---|---|---|---|
| number | Type of surfaces | radius | Thickness | Material |
| 1 | Object plane | Infinite | — | — |
| 2 | Aperture slot | Infinite | 0.10 mm | — |
| 3 | Spherical plane | Infinite | 0.30 mm | Silicon |
| 4 | Structural | Infinite | 0.11 mm | — |
| | surface (Aperture | | | |
| | slot) | | | |
| 5 | Spherical plane | −3.86 mm | 1.37 mm | Silicon |
| 6 | Spherical plane | −2.00 mm | 0.76 mm | — |
| 7 | Spherical plane | Infinite | 0.50 mm | Silicon |
| 8 | Spherical plane | Infinite | 0.10 mm | — |
| 9 | Image plane | Infinite | — | — |

The explanation of Table 9 refers to the explanation of Table 3, and will not repeat here.

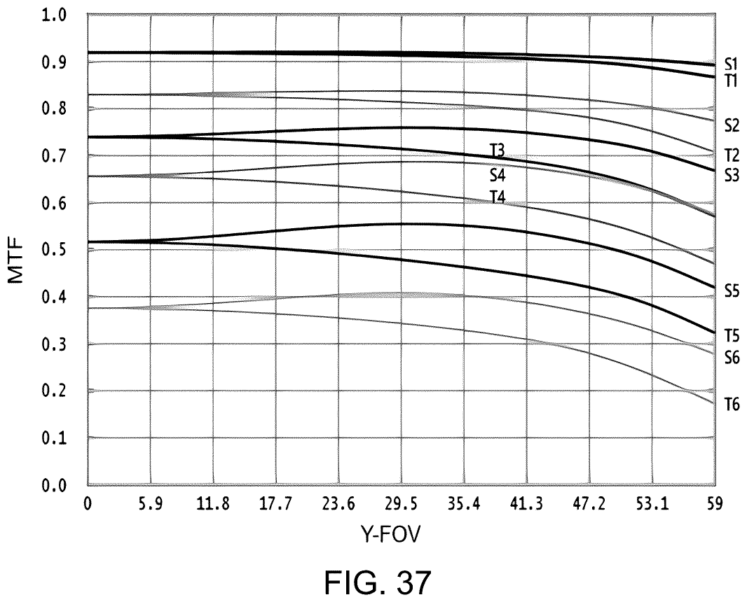

FIG. 37 shows a curve diagram at room temperature between the MTF and field of view of the optical system working at the far-infrared waveband in Embodiment 4 provided by the present application. Similarly, for the meaning of the horizontal and vertical axis of FIG. 4 and the meaning of each curve, the meaning of the horizontal and vertical axis of FIG. 26 and each curve will not be repeated here.

As shown in FIG. 37, the optical system provided by the present application at room temperature has an MTF of at a cut-off frequency of 42.00 cyc/mm greater than 0.16 at all fields of view all the time, that is, the MTF of cut-off frequency of 42.00 cyc/mm is greater than the target requirement of 0.15 at all fields of view all the time, which indicates that image quality of the optical system at room temperature is good. Similarly, for the interpretation of other aspects of the performance index of the optical system reflected in FIG. 4, the other aspects of the performance index of the optical system reflected in FIG. 37 will not be repeated here.

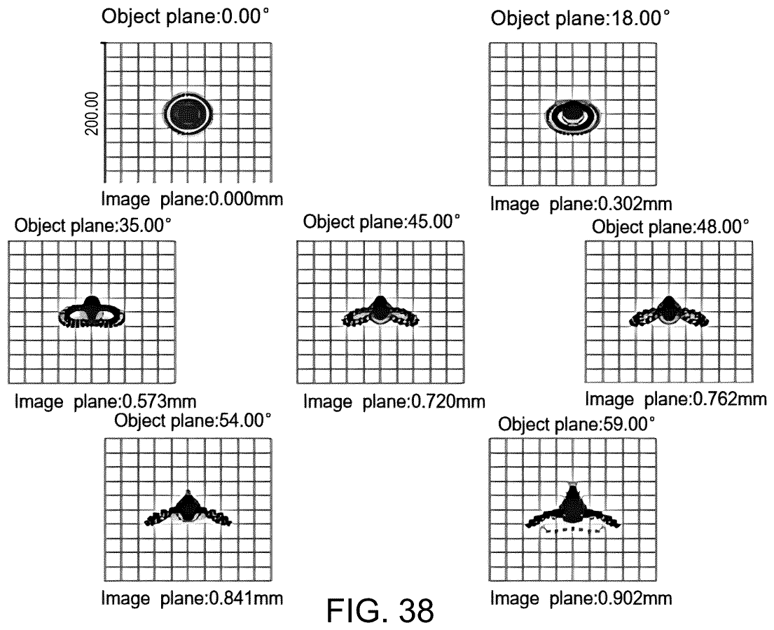

FIG. 38 shows a spot diagram at room temperature of the optical system working at the far-infrared waveband in Embodiment 4. FIG. 38 shows spot diagrams of imaging of wavelengths at 8 μm, 10 μm and 12 μm. As can be seen from FIG. 38, the optical system provided in this embodiment has dense imaging spots at wavelengths of 8 μm, 10 μm and 12 μm, thus indicating that the optical system has excellent imaging quality at the waveband from 8 μm to 12 μm at room temperature.

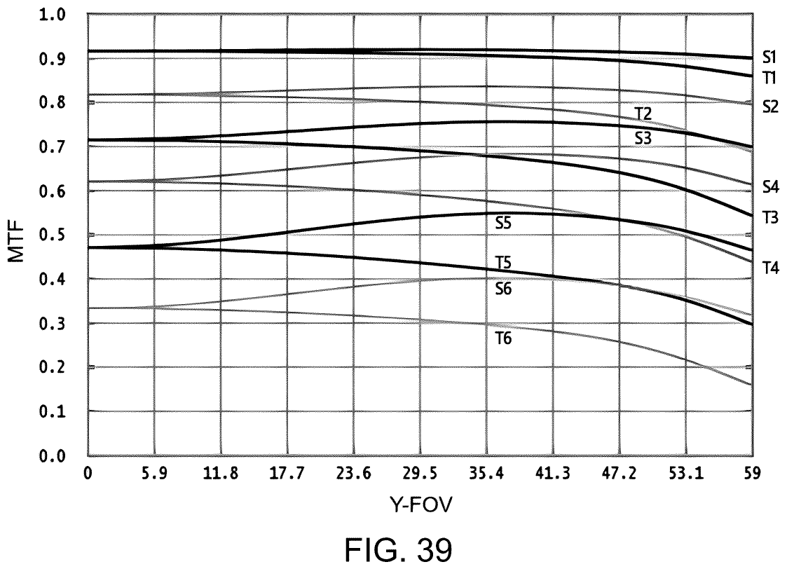

FIG. 39 shows a curve diagram at the temperature of −40° C. between the MTF and field of view of the optical system working at the far-infrared waveband in Embodiment 4 provided by the present application. Similarly, the meaning of the horizontal and vertical axis and the meaning of each curve are the same as the description of FIG. 4, the meaning of the horizontal and vertical axis and each curve in FIG. 39 will not be repeated here.

From FIG. 39 can be seen, the optical system provided by the present application, the MTF at a cut-off frequency of 42 cyc/mm is greater than 0.18, that is, the MTF is greater than the target requirement of 0.15, which indicates that image quality of the optical system at the temperature of −40° C. is good. Similarly, other performance indices reflected in the optical system in FIG. 39 are the same as the performance indices in FIG. 4, which will not repeat here.

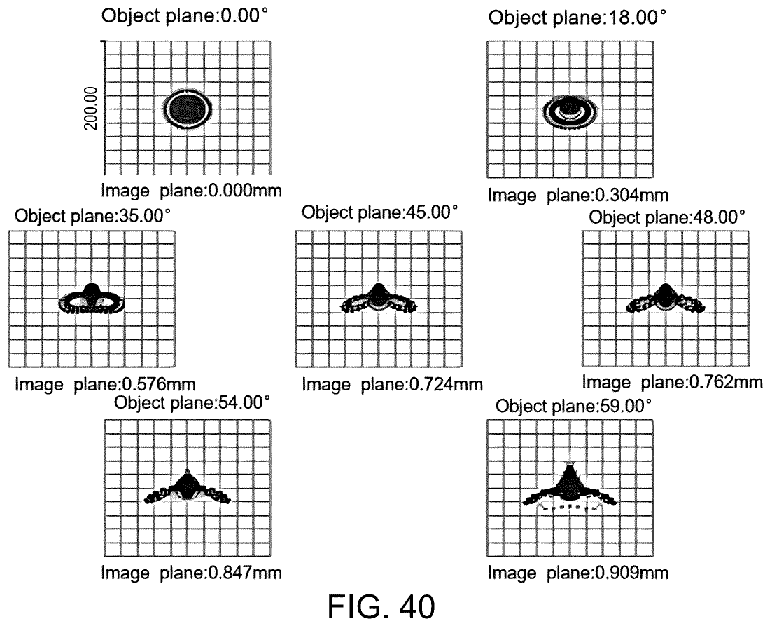

FIG. 40 shows a spot diagram of imaging at temperature of −40° C. in Embodiment 4. FIG. 40 shows spot diagrams of imaging at the wavelengths of 8 μm, 10 μm and 12 μm. As shown in FIG. 40, in the optical system provided by the present embodiment, the imaging spots are denser at the wavelengths of 8 μm, 10 μm and 12 μm. Thus, the optical system at temperature of −40° C. has excellent imaging quality.

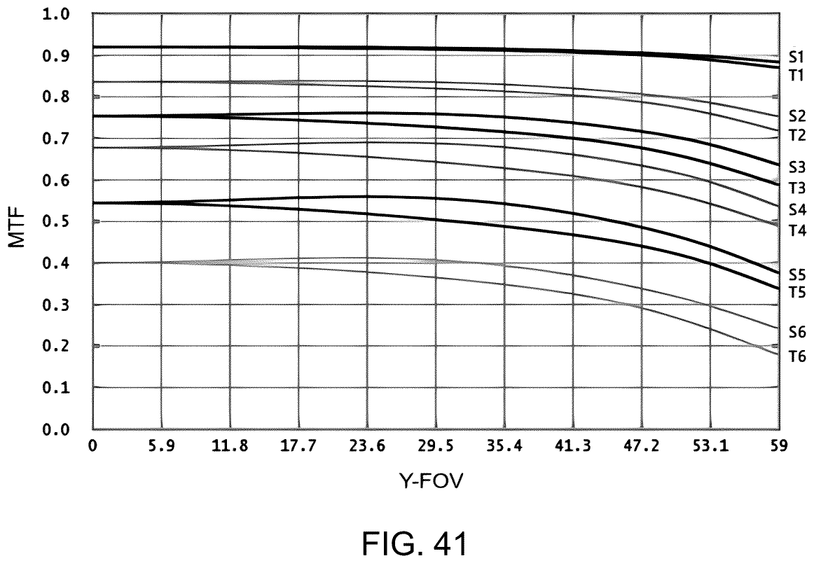

FIG. 41 shows a curve diagram at the temperature of 80° C. between the MTF and field of view of the optical system working at the far-infrared waveband in Embodiment 4. Similarly, the meaning of the horizontal and vertical axis and the meaning of each curve are the same as the description of FIG. 41, the meaning of the horizontal and vertical axis and each curve will not be repeated here.

It can be seen in FIG. 41, MTF at a cut-off frequency of 42.00 cyc/mm is greater than 0.18 at all fields of view all the time. That is, MTF is greater than the target requirement of 0.15, which indicates that the optical system at temperature of 80° C. has good imaging quality at all fields of view. Similarly, the meaning of the horizontal and vertical axis and the meaning of each curve are the same as the description of FIG. 4, the meaning of the horizontal and vertical axis and each curve in FIG. 30 will not be repeated here.

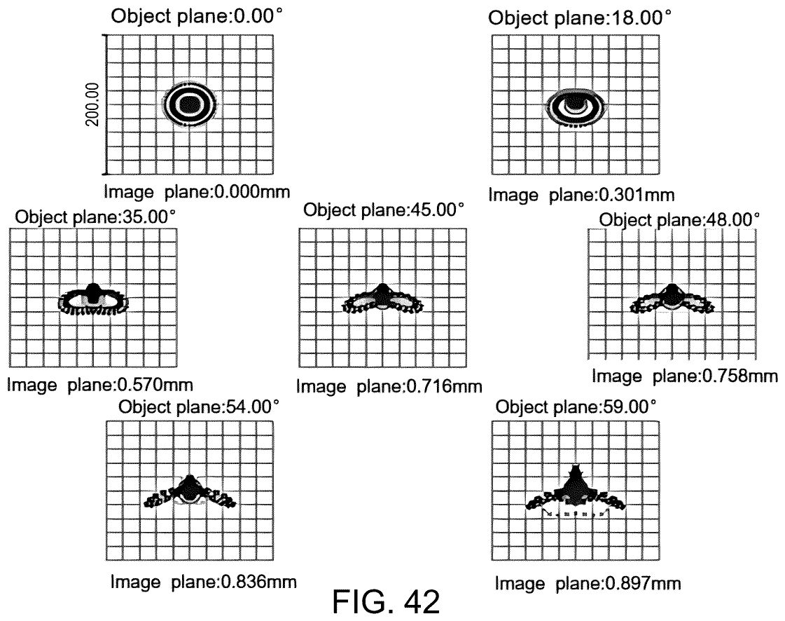

FIG. 42 shows a spot diagram of the optical system at a temperature of 80° C. provided by the present application. FIG. 42 shows spot diagrams of imaging of wavelengths at 8 μm, 10 μm and 12 μm. As can be seen from FIG. 42, the optical system provided in this embodiment has dense imaging spots at wavelengths of 8 μm, 10 μm and 12 μm, thus indicating that the optical system has excellent imaging quality at the waveband from 8 μm to 12 μm at room temperature.

From FIG. 37 to FIG. 42, the optical system provided by the present application at the temperature from −40° C. to 80° C. keeps good image quality at the wavelength of 8-12 μm all the time, which indicates that the optical system has fully realized the athermalization.

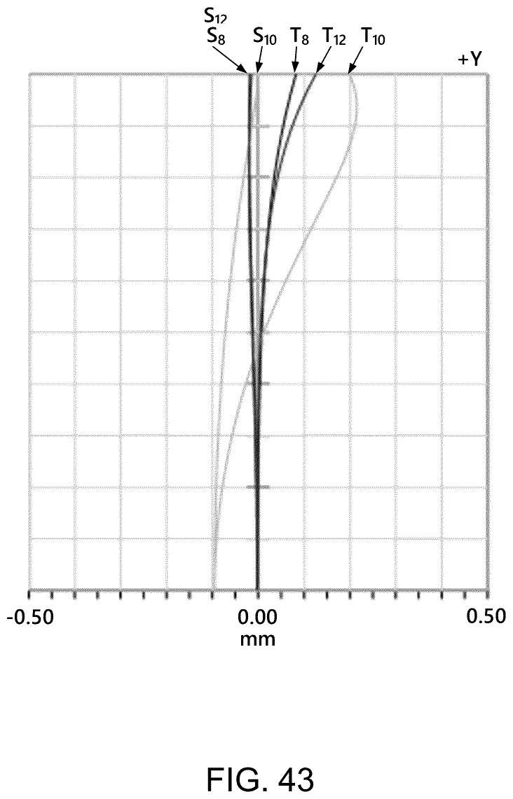

FIG. 43 shows a field curvature in Embodiment 3. Similarly, the meaning of the curve of field curvature and the meaning of each curve are the same as the description of FIG. 10, the meaning of each curve will not be repeated here.

It can be seen from FIG. 43, at the wavelengths from 8-12 μm, the field curvature is less than 0.30 mm, thus the field curvature of the optical system is smaller.

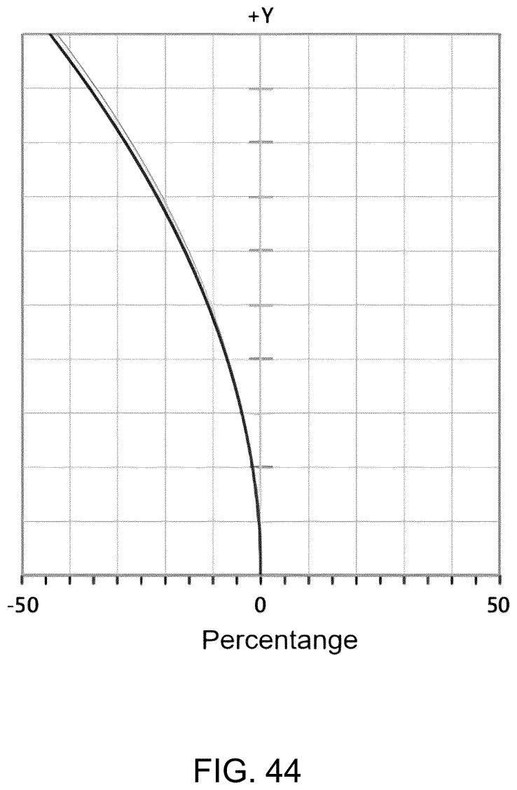

FIG. 44 shows a distortion diagram of the optical system. Similarly, the meaning of the curve of distortion and the meaning of each curve are the same as the description of FIG. 11, the meaning of each curve will not be repeated here.

It can be seen from FIG. 44, at the wavelengths of 8-12 μm, the distortion of the optical system is less than 50%, which satisfies the distortion of target requirements of the optical system.

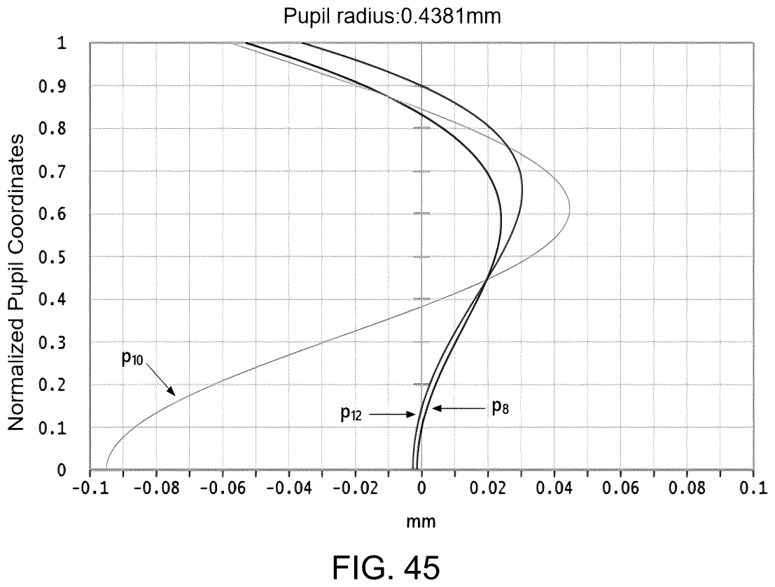

FIG. 45 shows a wavefront aberration diagram in the axial direction of the optical system provided by embodiment 4. Similarly, the meaning of the horizontal and vertical axis and the meaning of each curve are the same as the description of FIG. 12, the meaning of each curve will not be repeated here.

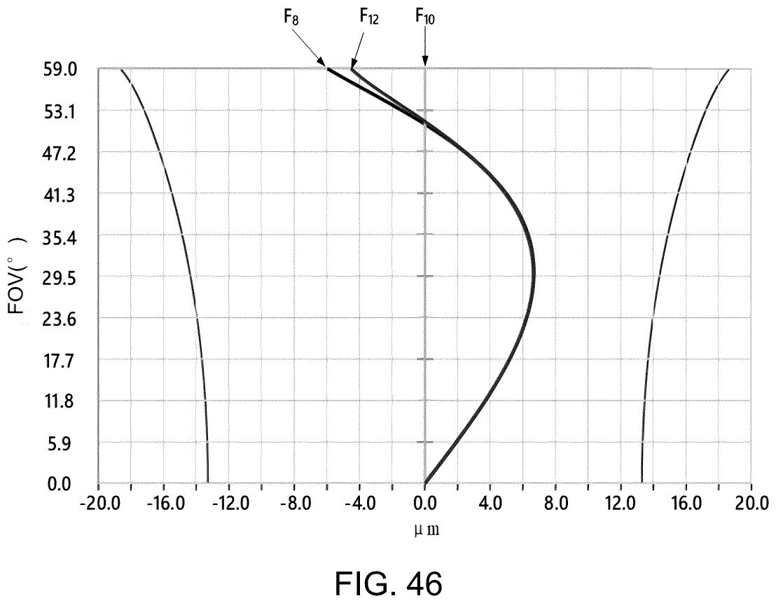

It can be seen from FIG. 46, at each wavelength from 8-12 μm, the axial wavefront aberration of the optical system is less than 0.01 mm, thus the spherical aberration of the optical system is smaller; and the three axial aberration curves of P₈, P₁₀ and P₁₂ are relatively dense, which indicates that the chromatic aberration is smaller.

FIG. 46 shows a chromatic aberration diagram in the vertical axis direction of the optical system working at the far-infrared waveband in one embodiment provided by the present application. Similarly, the meaning of the horizontal and vertical axis and the meaning of each curve are the same as the description of FIG. 4, the meaning of the horizontal and vertical axis and each curve in FIG. 46 will not be repeated here.

It can be seen from FIG. 46, in the wavelength of 8-12 μm, the chromatic aberration in the direction of vertical axis is located at the diameter range of Airy disk, and still has a lot of margins, thus the chromatic aberration has been well compensated.

### Embodiment 5

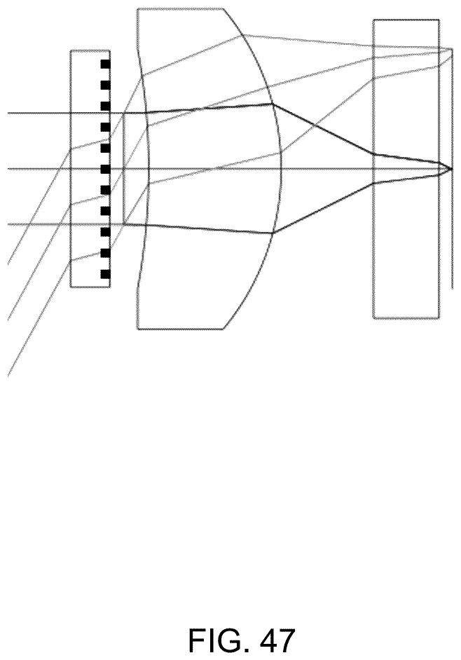

FIG. 47 shows a schematic diagram of the architectural layout of the optical system and the optical camera working at the far-infrared waveband in Embodiment 5. As shown in FIG. 47, in Embodiment 5, the optical system working at a far-infrared waveband, including 4 optical elements, the 4 optical elements being, along the optical axis in order from an object side to an image side: a metalens, an aperture slot, a refractive lens and an optical window glass. The aperture slot is set on the image-side surface of the metalens.

TABLE 10
The various system parameters
of the optical system

| System Parameters | Data | |
|---|---|---|
| TTL | 2.90 | mm |
| FOV | 122.7° | |
| F number | 1.1 | |
| Effective focal length | 0.92 | mm |
| Working waveband | 8~12 | μm |

As can be seen from Table 10, the optical system provided by the present application works at the waveband from 8 μm to 12 μm; the optical system has a TTL of 2.90 mm, and the TTL is less than that in the target requirement of 3.8 mm, which can fully satisfy the requirement of miniaturization. The F number of the optical system is 1.09 and the F number is less than the target requirement of 1.1, which can fully satisfy the requirements of the optical system for light intake.

Along the direction from the object side to the image side, each surface of the optical system is numbered. After summarizing the parameters of each surface, Table 11 is obtained as shown below.

TABLE 11
parameters of each surface of the
optical system in Embodiment 5

| Surface | | Curvature | | |
|---|---|---|---|---|
| number | Type of surfaces | radius | Thickness | Material |
| 1 | Object plane | Infinite | — | — |
| 2 | Spherical plane | Infinite | 0.30 mm | Silicon |
| 3 | Structural | Infinite | 0.11 mm | — |
| | surface | | | |
| 4 | Aperture slot | Infinite | 0.19 mm | — |
| 5 | Spherical plane | −4.97 mm | 1.00 mm | Silicon |
| 6 | Spherical plane | −1.90 mm | 0.70 mm | — |
| 7 | Spherical plane | Infinite | 0.50 mm | Silicon |
| 8 | Spherical plane | Infinite | 0.10 mm | — |
| 9 | Image plane | Infinite | — | — |

The explanation of Table 11 refers to the explanation of Table 3, and will not repeat here.

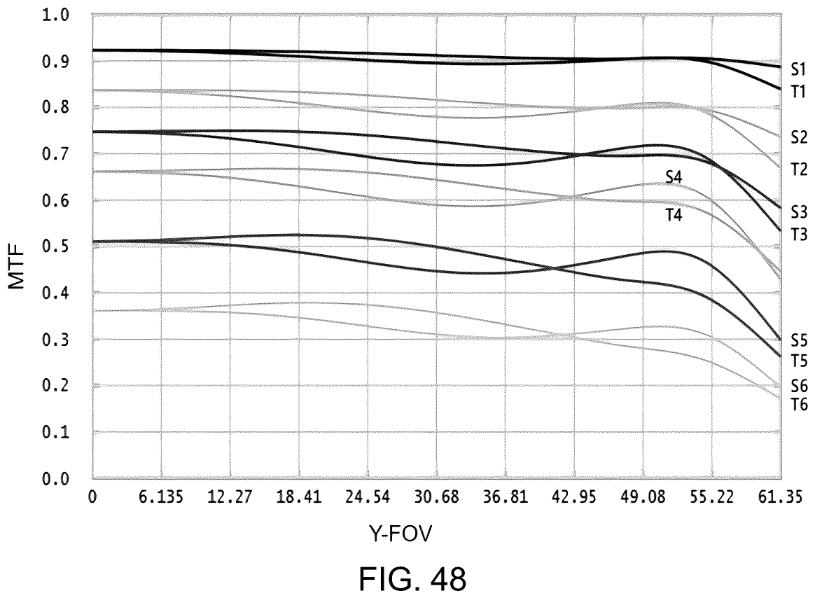

FIG. 48 shows a curve diagram at room temperature between the MTF and field of view of the optical system working at the far-infrared waveband in Embodiment 5 provided by the present application. Similarly, for the meaning of the horizontal and vertical axis of FIG. 4 and the meaning of each curve, the meaning of the horizontal and vertical axis of FIG. 48 and each curve will not be repeated here.

As shown in FIG. 48, the optical system provided by the present application at room temperature has an MTF of at a cut-off frequency of 42.00 cyc/mm greater than 0.17 at all fields of view all the time, that is, the MTF of a cut-off frequency of 42.00 cyc/mm is greater than the target requirement of 0.15 at all fields of view all the time, which indicates that image quality of the optical system at room temperature is good. Similarly, for the interpretation of other aspects of the performance index of the optical system reflected in FIG. 4, the other aspects of the performance index of the optical system reflected in FIG. 48 will not be repeated here.

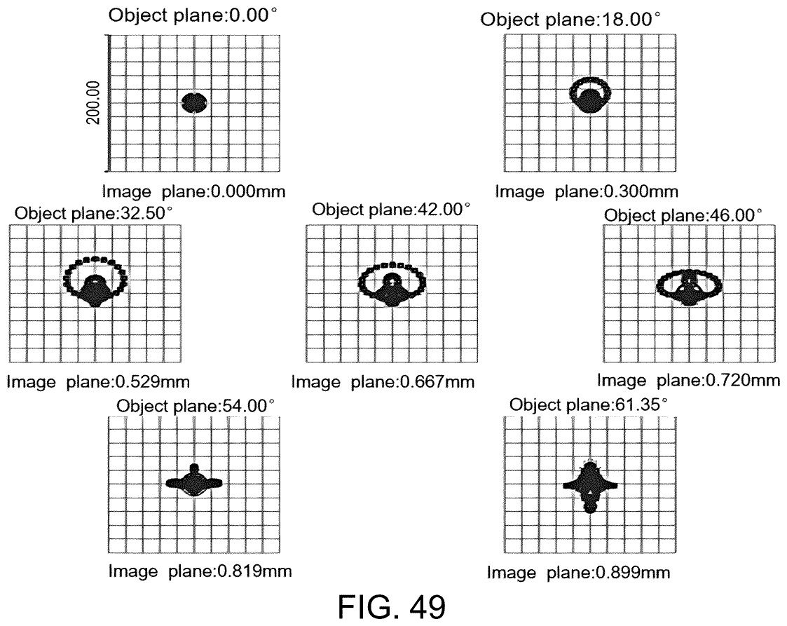

FIG. 49 shows a spot diagram at room temperature of the optical system working at the far-infrared waveband in Embodiment 5. FIG. 49 shows spot diagrams of imaging of wavelengths at 8 μm, 10 μm and 12 μm. As can be seen from FIG. 49, the optical system provided in this embodiment has dense imaging spots at wavelengths of 8 μm, 10 μm and 12 μm, thus indicating that the optical system has excellent imaging quality at the waveband from 8 μm to 12 μm at room temperature.

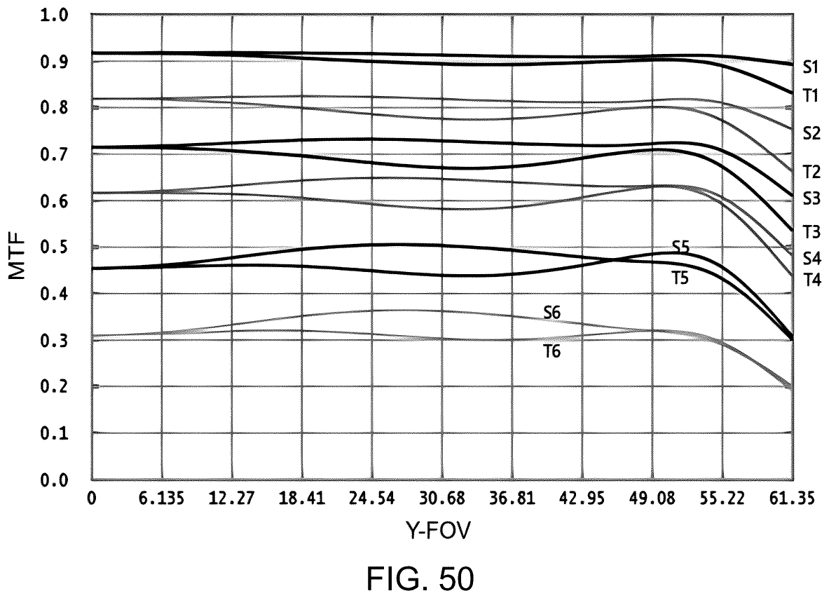

FIG. 50 shows a curve diagram at the temperature of −40° C. between the MTF and field of view of the optical system working at the far-infrared waveband in Embodiment 5 provided by the present application. Similarly, the meaning of the horizontal and vertical axis and the meaning of each curve are the same as the description of FIG. 4, the meaning of the horizontal and vertical axis and each curve in FIG. 50 will not be repeated here.

From FIG. 50 can be seen, the optical system provided by the present application, the MTF at a cut-off frequency of 42 cyc/mm is greater than 0.19, that is, the MTF is greater than the target requirement of 0.15, which indicates that image quality of the optical system at the temperature of −40° C. is good. Similarly, other performance indices reflected in the optical system in FIG. 50 are the same as the performance indices in FIG. 4, which will not repeat here.

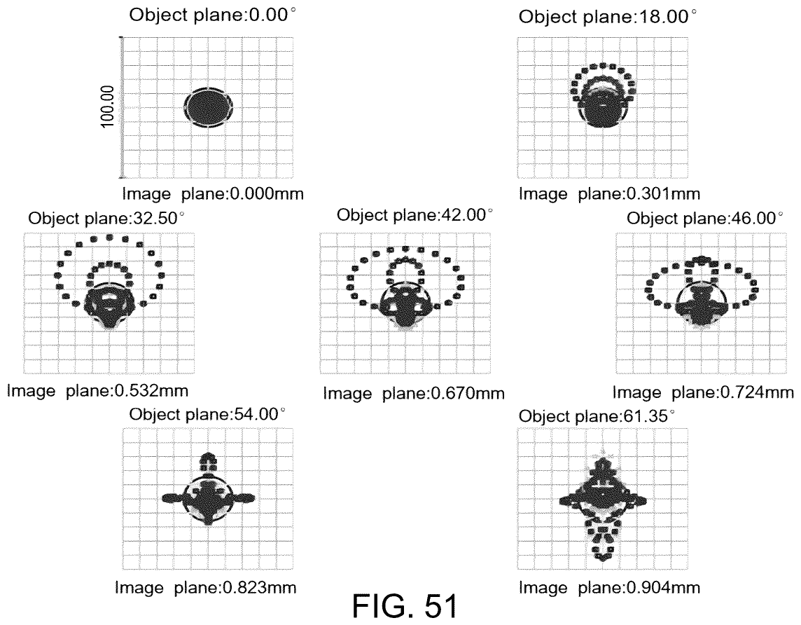

FIG. 51 shows a spot diagram of imaging at a temperature of −40° C. in Embodiment 5. FIG. 51 shows spot diagrams of imaging at the wavelengths of 8 μm, 10 μm and 12 μm. As shown in FIG. 51, in the optical system provided by the present embodiment, the imaging spots are denser at the wavelengths of 8 μm, 10 μm and 12 μm. Thus, the optical system at temperature of −40° C. has excellent imaging quality.

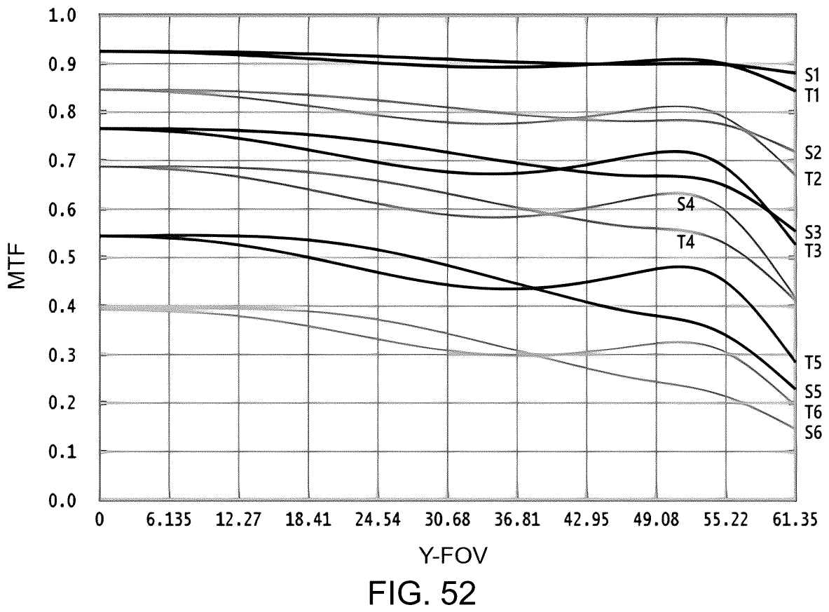

FIG. 52 shows a curve diagram at the temperature of 80° C. between the MTF and field of view of the optical system working at the far-infrared waveband in Embodiment 5. Similarly, the meaning of the horizontal and vertical axis and the meaning of each curve are the same as the description of FIG. 52, the meaning of the horizontal and vertical axis and each curve will not be repeated here.

It can be seen in FIG. 52, MTF at a cut-off frequency of 42.00 cyc/mm is greater than the target requirement of 0.15, which indicates that the optical system at temperature of 80° C. has good imaging quality at all fields of view. Similarly, the meaning of the horizontal and vertical axis and the meaning of each curve are the same as the description of FIG. 4, the meaning of the horizontal and vertical axis and each curve in FIG. 52 will not be repeated here.

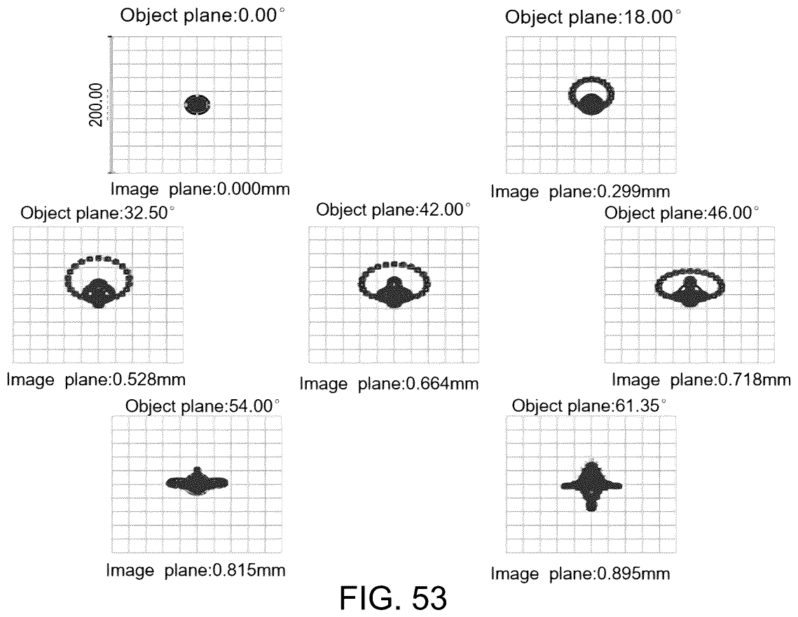

FIG. 53 shows a spot diagram of the optical system at temperature of 80° C. provided by the present application. FIG. 53 shows spot diagrams of imaging of wavelengths at 8 μm, 10 μm and 12 μm. As can be seen from FIG. 53, the optical system provided in this embodiment has dense imaging spots at wavelengths of 8 μm, 10 μm and 12 μm, thus indicating that the optical system has excellent imaging quality at the waveband from 8 μm to 12 μm at room temperature.

From FIG. 48 to FIG. 53, the optical system provided by the present application at the temperature from −40° C. to 80° C. keeps good image quality at the wavelength of 8-12 μm all the time, which indicates that the optical system has fully realized the athermalization.

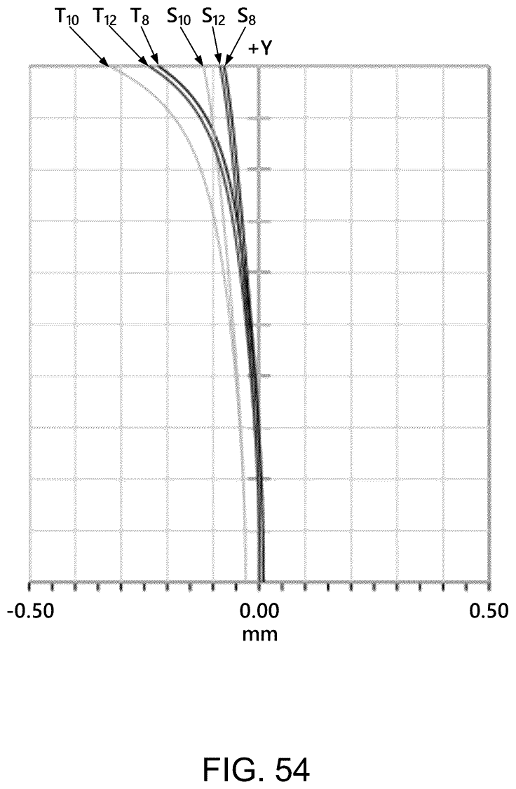

FIG. 54 shows a field curvature in Embodiment 5. Similarly, the meaning of the curve of field curvature and the meaning of each curve are the same as the description of FIG. 10, the meaning of each curve will not be repeated here.

It can be seen from FIG. 54, at the wavelengths from 8-12 μm, the field curvature is less than 0.30 mm, thus the field curvature of the optical system is smaller.

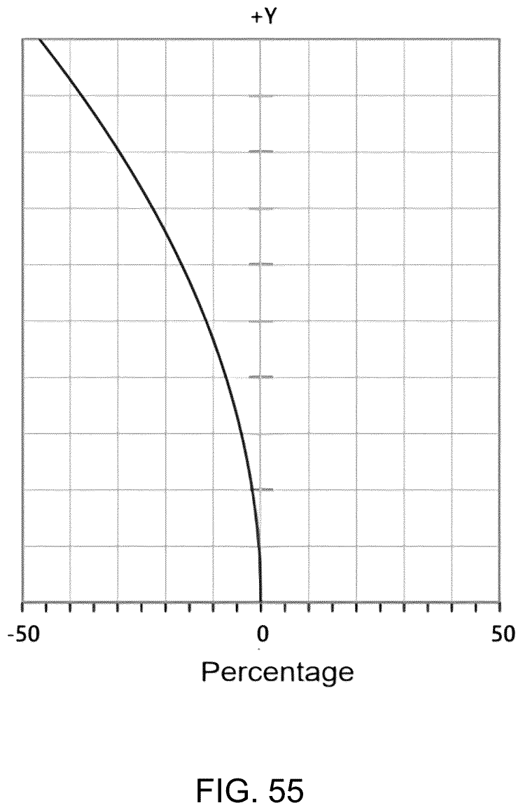

FIG. 55 shows a distortion diagram of the optical system. Similarly, the meaning of the curve of distortion and the meaning of each curve are the same as the description of FIG. 11, the meaning of each curve will not be repeated here.

It can be seen from FIG. 55, at the wavelengths of 8-12 μm, the distortion of the optical system is less than 50%, which satisfies the distortion of target requirements of the optical system.

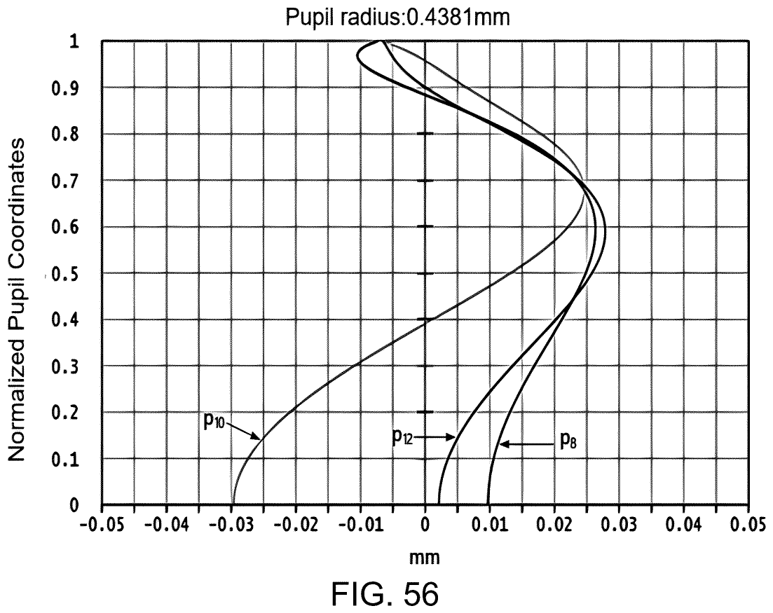

FIG. 56 shows a wavefront aberration diagram in the axial direction of the optical system provided by embodiment 5. Similarly, the meaning of the horizontal and vertical axis and the meaning of each curve are the same as the description of FIG. 12, the meaning of each curve will not be repeated here.

It can be seen from FIG. 56, at each wavelength from 8-12 μm, the axial wavefront aberration of the optical system is less than 0.03 mm, thus the spherical aberration of the optical system is smaller.

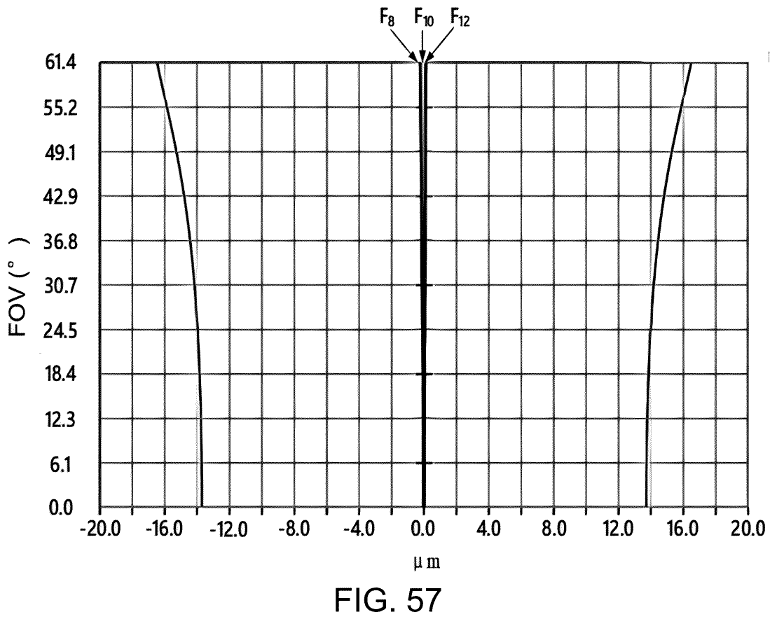

FIG. 57 shows a chromatic aberration diagram in the vertical axis direction of the optical system working at the far-infrared waveband in one embodiment provided by the present application. Similarly, the meaning of the horizontal and vertical axis and the meaning of each curve are the same as the description of FIG. 4, the meaning of the horizontal and vertical axis and each curve in FIG. 57 will not be repeated here.

It can be seen from FIG. 57, in the wavelength of 8-12 μm, the chromatic aberration in the direction of vertical axis is located at the diameter range of Airy disk, and still has a lot of margins, thus the chromatic aberration has been well compensated.

After summarizing the lens parameters of the optical system provided by the above seven embodiments, Table 14 is shown below. The displays in Table 14 mainly are used to explain the conditions met by the optical system provided in this application, and are experimentally verified and supported.

TABLE 12
The lens parameters of the optical system provided by the present embodiments

| Condition | Embodiment1 | Embodiment2 | Embodiment3 | Embodiment4 | Embodiment5 |
|---|---|---|---|---|---|
| Fov | 122.6° | 122.6° | 122.7º | 118° | 122.7º |
| n₁ | 3.412 | | | | |
| TTL | 3.20 mm | 3.15 mm | 3.24 mm | 3.24 mm | 2.90 mm |
| f₂ | 1.08 mm | 1.09 mm | 1.09 mm | 1.13 mm | 1.03 mm |
| c₁ | -0.24/mm | -0.26/mm | -0.24/mm | -0.26/mm | -0.20/mm |
| c₂ | -0.50/mm | -0.50/mm | -0.49/mm | -0.50/mm | -0.53/mm |
| H | 1.45 mm | 1.40 mm | 1.50 mm | 1.37 mm | 1.00 mm |
| ϕₘ | 0.39/mm | 0.48/mm | 0.43/mm | 0.49/mm | 1/mm |
| L | 2.35 mm | 2.30 mm | 2.34 mm | 1.78 mm | 1.60 mm |
| BFL | 1.35 mm | 1.35 mm | 1.35 mm | 1.36 mm | 1.30 mm |
| $2 * arcsin ( \frac{\sqrt{2}}{2} {n}_{1} )$ | 180° | | | | |
| $\frac{k * σ + TTL}{{f}_{2}}$ | 17.78 | 17.57 | 17.65 | 17.03 | 18.35 |
| $\frac{( {c}_{1} - {c}_{2} ) * H}{{ϕ}_{m}}$ | 0.97 | 0.70 | 0.87 | 0.67 | 0.33 |
| $\frac{L}{BFL}$ | 1.74 | 1.70 | 1.73 | 1.31 | 1.23 |

The above is only a specific embodiment of the embodiments of this disclosure, but the scope of protection of the embodiment of this disclosure is not limited to this. And those skilled in the field can easily think of any change or substitution for this disclosure, which should be covered within the protection scope of this disclosure. Therefore, the scope of the protection of the present disclosure shall be the scope of the claims.

What is claimed is:

1. An optical system working at a far-infrared waveband, comprising two optical elements, the two optical elements being, along the optical axis in order from an object side to an image side: a metalens and a refractive lens;
each of two optical elements comprising an object-side surface facing towards the object side and an image-side surface facing towards the image side;
wherein the metalens comprises a substrate and a plurality of nanostructures, and the plurality of nanostructures are set on the image-side surface of the metalens; when a light passes through the image-side surface of the metalens, the incident angle of the light is less than or equal to 45°;
the object-side surface of the refractive lens is a concave surface, and the image-side surface of the refractive lens is a convex surface; and the refractive lens has positive refractive power.

2. The optical system according to claim 1, wherein the optical system satisfies the following condition:
$$2 * arcsin ( \frac{\sqrt{2}}{2} {n}_{1} ) > Fov ,$$
wherein Fov is a field of view of the optical system, and the unit of the Fov is expressed in degree; n is the refractive index.

3. The optical system according to claim 1, wherein the optical system satisfies the following condition:
$$15.25 \leq \frac{k * σ + TTL}{{f}_{2}} \leq 20. ,$$
wherein k is a correction coefficient, and the unit of k is expressed in mm*° C.; σ is a refraction temperature coefficient, and the unit of σ is expressed in 1/° C.; TTL is a total track length of the optical system, and the unit of TTL is expressed in mm; f₂ is a focal length of the refractive lens, and the unit of f₂ is expressed in mm.

4. The optical system according to claim 3, wherein the optical system satisfies the following condition:
$$16.14 \leq \frac{k * σ + TTL}{{f}_{2}} \leq 18.35 .$$

5. The optical system according to claim 1, wherein the optical system satisfies the following condition:
$$0.25 \leq \frac{( {c}_{1} - {c}_{2} ) * H}{{ϕ}_{m}} \leq 1.2 ,$$
wherein c₁ is a curvature radius of the object-side surface of the refractive lens and the unit of the curvature radius is expressed of 1/mm; c₂ is a curvature radius of the image-side surface of the refractive lens and the unit of the curvature radius is expressed of 1/mm; H is a thickness of the refractive lens and the unit of the thickness of the refractive lens is expressed in mm; ϕₘ is a focal power of the metalens and the unit of the focal power is expressed in 1/mm.

6. The optical system according to claim 5, wherein the optical system satisfies the following condition:
$$0.33 \leq \frac{( {c}_{1} - {c}_{2} ) * H}{{ϕ}_{m}} \leq 0.97 .$$

7. The optical system according to claim 1, wherein the optical system satisfies the following condition:
$$0.9 \leq \frac{L}{BFL} \leq 2. ,$$
wherein Lis a paraxial distance between the object-side surface of the metalens and the image-side surface of the refractive lens, BFL is a distance between the image-side surface of the refractive lens and image plane; and the unit of L and BFL are the same.

8. The optical system according to claim 7, wherein the optical system satisfies the following condition:
$$1.23 \leq \frac{L}{BFL} \leq 1.74 .$$

9. The optical system according to claim 1, wherein the plurality nanostructures are positive nanostructures.

10. The optical system according to claim 1, wherein the plurality nanostructures are negative nanostructures.

11. The optical system according to claim 1, wherein the optical system also comprises an aperture slot; the aperture slot is next to the metalens and is set on the surface of the metalens.

12. The optical system according to claim 1, wherein the optical system also comprises an aperture slot, and an air gap is set between the aperture slot and the metalens.

13. The optical system according to claim 1, wherein the optical system comprises an optical window; the optical window is set between the refractive lens and the image plane.

14. The optical system according to claim 1, wherein the field of view of the optical system satisfies:
$$117 ° \leq Fov \leq 123 ° ,$$
wherein Fov is a field of view of the optical system.

15. The optical system according to claim 1, wherein the total track length of the optical system is less than or equal to 3.8 mm.

16. The optical system according to claim 1, wherein the distortion of the optical system is less than 50%.

17. The optical system according to claim 1, wherein the F number of the optical system is less than or equal to 1.1.

18. An optical camera working at a far-infrared waveband, wherein the optical camera comprises a lens barrel and the optical system claimed as claim 1;
an inner wall of the lens barrel is set with a staircase structure;
the metalens and refractive lens are set on the staircase structure;
the optical camera further comprises a connection structure, and the connection structure is used to fix the metalens and refractive lens on the staircase structure.

19. The optical camera according to claim 18, wherein the connection structure is a pressure ring.

20. The optical camera according to claim 18, wherein the connection structure is dispensing.
